(19) United States
(12) Patent Application Publication
(10) Pub. No.: US 2016/0063414 A1
(43) Pub. Date: Mar. 3, 2016

(54) METHODS AND SYSTEMS FOR CONFIGURING A METHANOL PRODUCTION FACILITY

(71) Applicants: Air Liquide Global E&C Solutions US Inc., Houston, TX (US); Air Liquide Large Industries U.S. LP, Houston, TX (US); L'Air Liquide, Société Anonyme pour l'Etude et l'E, Paris (FR); Air Liquide Global E&C Solutions Germany GmbH, Franfurt am Main (DE)

(72) Inventors: Alain GUILLARD, Houston, TX (US); Alexander ROESCH, Katy, TX (US); Erik Jon ANDERSON, Houston, TX (US); Siva ARIYAPADI, Bellaire, TX (US); Francois FUENTES, Le Vesinet (FR); Veronika GRONEMANN, Karben (DE); Paul Manfred KRIMLOWSKI, Frankfurt (DE); Jakob Balthasar PERLWITZ, Frankfurt (DE); Krishna Anand PUNWASI, Humble, TX (US); Bharatkumar SONI, Sugar Land, TX (US); Etienne Jean STURM, Katy, TX (US)

(21) Appl. No.: 14/475,054

(22) Filed: Sep. 2, 2014

(51) Int. Cl. G06Q 10/06

(52) U.S. Cl. CPC G06Q 10/06313; G06Q 10/0637; G06Q 10/0635

(57) ABSTRACT

A method includes receiving input corresponding to a proposed configuration of a methanol production facility and identifying a plurality of components utilized to produce methanol at the facility. The method includes determining an alternative configuration that is different from the proposed configuration. Determining the alternative configuration may include identifying resources accessible to a proposed location for the methanol production facility and whether at least one of the resources accessible to the proposed location corresponds to a resource generated by a component identified by the proposed configuration, and determining whether to omit at least one component of the plurality of components identified by the proposed configuration. The method includes omitting the at least one component from the alternative configuration, and generating a report based on the proposed configuration and the alternative configuration. The report includes information indicating a difference between the proposed configuration and the alternative configuration.

### TECHNICAL FIELD

The present disclosure generally relates to determining a configuration of a methanol production facility, and, in particular, determining a recommended configuration for constructing a methanol production facility.

### BACKGROUND OF THE INVENTION

Demand for methanol is increasing and has resulted in an increased demand for methanol production. Presently, methanol production facilities are constructed as standalone facilities that require little, if any, resources from external sources. Constructing a methanol production facility requires large capital expenditures, often approaching or exceeding one billion dollars prior to beginning methanol production. Furthermore, the sales price of methanol, like other commodities such as oil and natural gas, fluctuates almost daily. This fluctuation in price, in conjunction with the extremely high construction costs, creates uncertainty for entities contemplating construction of or financing of a methanol production facility or other type of refinery.

### BRIEF SUMMARY OF THE INVENTION

Systems, methods, apparatuses, and computer-readable storage devices for determining a recommended configuration for constructing a methanol production facility are disclosed. Determining the recommended configuration for constructing the methanol production facility may include determining whether to construct the methanol production facility with a plurality of components that produce resources (e.g., oxygen, hydrogen, nitrogen, etc.) utilized during the production of methanol, or whether to construct the methanol production facility without one or more of the plurality of components. The configuration of the methanol production facility may be determined based on geographic information, availability of alternative sources for the resources (e.g., sources other than the plurality of components), costs for transporting the resources from the alternative sources to the methanol production facility, regulations associated with constructing and operating the methanol production facility, a desired internal rate of return (IRR) for the methanol production facility, other factors, or a combination thereof.

Constructing the methanol production facility with the plurality of components may require a greater initial capital expenditure (CapEx) than constructing the methanol production facility without one or more of the plurality of components. However, operational expenses (OpEx) for producing methanol at a methanol production facility that includes the plurality of components may be lower than an OpEx for producing methanol at a methanol production facility that does not include one or more of the plurality of components. Systems, methods, and apparatuses disclosed herein may be configured to receive a proposed configuration for a methanol production facility, and, based on the proposed configuration, generate at least one alternative configuration for the methanol production facility. An amount of CapEx required to construct the methanol production facility using any of the at least one alternative configurations is lower than an amount of CapEx required to construct the methanol production facility using the proposed configuration, however, OpEx for producing methanol at the methanol production facility is higher using any of the at least one alternative configurations relative to the proposed configuration. The systems, methods, and apparatuses may also be configured to generate a report that includes estimates of CapEX and OpEx for each configuration (e.g., the proposed configuration and at least one of the alternative configurations) of the methanol production facility. The report may also include an estimated internal rate of return (IRR) for each configuration of the methanol facility, and may also include one or more geographic location recommendations associated with constructing the methanol facility using at least one of the alternative configurations.

Configuring a methanol production facility according to one or more of the aspects disclosed herein may also reduce or eliminate delays for initiating production of methanol at the methanol production facility and increase operational reliability of the methanol production facility. Methanol production facilities configured according to one or more aspects of the present disclosure may also be scaled up to the proposed configuration incrementally over time, and operational safety of the methanol production facility may be increased. Additional aspects for configuring a methanol production facility, and benefits provided by configuring the methanol production facility according to the present disclosure are described in more detail.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a system operable to determine an alternative configuration for a methanol production facility;

FIG. 2 is a block diagram illustrating various configuration options for configuring a methanol production facility;

FIG. 3 is a diagram illustrating exemplary aspects of determining an alternative location for constructing a methanol facility;

FIG. 4 is a flow chart illustrating exemplary aspects of a method for determining a configuration of a methanol production facility;

FIG. 5 is block diagram of an exemplary proposed configuration for a methanol production facility;

FIG. 6 is a block diagram of a first alternative configuration for a methanol production facility;

FIG. 7 is a block diagram of a second alternative configuration for a methanol production facility;

FIG. 8 is a table illustrating exemplary consumption and production data for a proposed configuration of a methanol production facility and two alternative configurations for the methanol production facility;

FIG. 9 a table illustrating aspects of operational expenses for operating a methanol production facility according to a proposed configuration and two alternative configurations; and

FIG. 10 is a table illustrating aspects of capital expenditure for constructing a methanol production facility according to a proposed configuration and two alternative configurations.

### DETAILED DESCRIPTION OF THE INVENTION

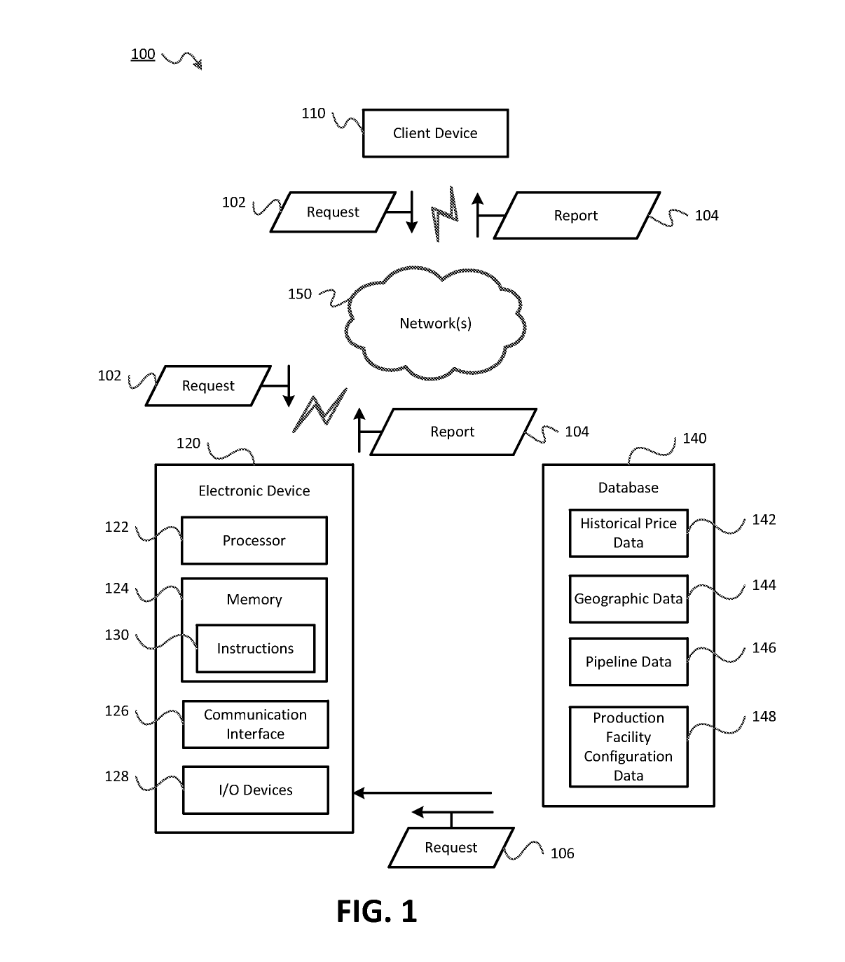

Referring to FIG. 1, a block diagram of a system operable to determine an alternative configuration for a methanol production facility is shown as a system 100. As shown in FIG. 1, the system 100 includes a client device 110, an electronic device 120, a database 140, and a network(s) 150. In an aspect, the client device 110 may be a personal computing device, a laptop computing device, a tablet computing device, a smartphone, or any other electronic device operable to perform the operations of the client device 110.

As shown in FIG. 1, the electronic device 120 includes a processor 122, a memory 124, a communication interface 126, and input/output (I/O) devices 128. In an aspect, the electronic device 120 may be a personal computing device, a laptop computing device, a tablet computing device, a smartphone, or any other electronic device operable to perform the operations of the electronic device 120. The memory 124 may store instructions 130. The memory 124 may include random access memory (RAM) devices, read only memory (ROM) devices, one or more hard disk drives (HDDs), flash memory devices, solid state drives (SSDs), erasable programmable read only memory (EPROM) devices, electrically erasable programmable read only memory (EEPROM) devices, magneto-resistive random access memory (MRAM) devices, optical memory devices, cache memory devices, other memory devices configured to store data in a persistent or non-persistent state, or a combination of different memory devices. Furthermore, the memory 124 may include computer-readable storage devices such as a compact disk (CD), a re-writable CD, a digital video disc (DVD), a re-rewritable DVD, etc. The memory 124 may store instructions 130. The instructions 130, when executed by the processor 122, may cause the processor 122 to perform the operations associated with determining an alternative configuration for a methanol production facility, described herein with reference to FIGS. 1-4.

The I/O devices 128 may include a printer, a mouse, a keyboard, a touchscreen display device, a scanner, a numeric keypad, other types of I/O devices, or a combination thereof. The communication interface 126 may be configured to communicatively couple the electronic device 120 to one or more networks, such as the network(s) 150, as shown in FIG. 1. The communication interface 126 may be configured to communicatively couple the electronic device 120 to the network 150 via a wired or wireless connection established according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3^{rd} Generation (3G) protocol, a 4^{th} Generation (4G)/long term evolution (LTE) protocol, etc.).

The network(s) 150 may be a wired network, a wireless network, or may include a combination of wired and wireless networks. For example, the network 150 may be a local area network (LAN), a wide area network (WAN), a wireless WAN, a wireless LAN (WLAN), a metropolitan area network (MAN), a wireless MAN network, a cellular data network, a cellular voice network, the internet, another type of network, or a combination of these networks. Additionally, the network(s) 150 may include multiple networks operated by different entities (e.g., different network service providers).

The electronic device 120 may be in communication with a database, such as the database 140, and may use information stored at the database 140 to determine the alternative configuration of the methanol production facility. In an aspect, the database 140 may be stored at the electronic device 120 (e.g., at the memory 124). In an additional or alternative aspect, the database 140 may be stored external to the electronic device 120 (e.g., at a network storage device not shown in FIG. 1), and may be accessible to the electronic device 120 via the network(s) 150. Additionally or alternatively, the database 140 may be a distributed database stored at a plurality of locations and/or storage devices accessible to the electronic device 120 via the network(s) 150.

During operation, the electronic device 120 may receive a request 102 from the client device 110 via the network(s) 150. The request 102 may include information associated with a proposed configuration for the methanol production facility. For example, the request 102 may include information specifying a plurality of components that are to be integrated to construct the methanol production facility. Once constructed, the plurality of components are operational to receive a feedstock (e.g., methane) and to transform the feedstock into methanol using a series of chemical reactions and other processes.

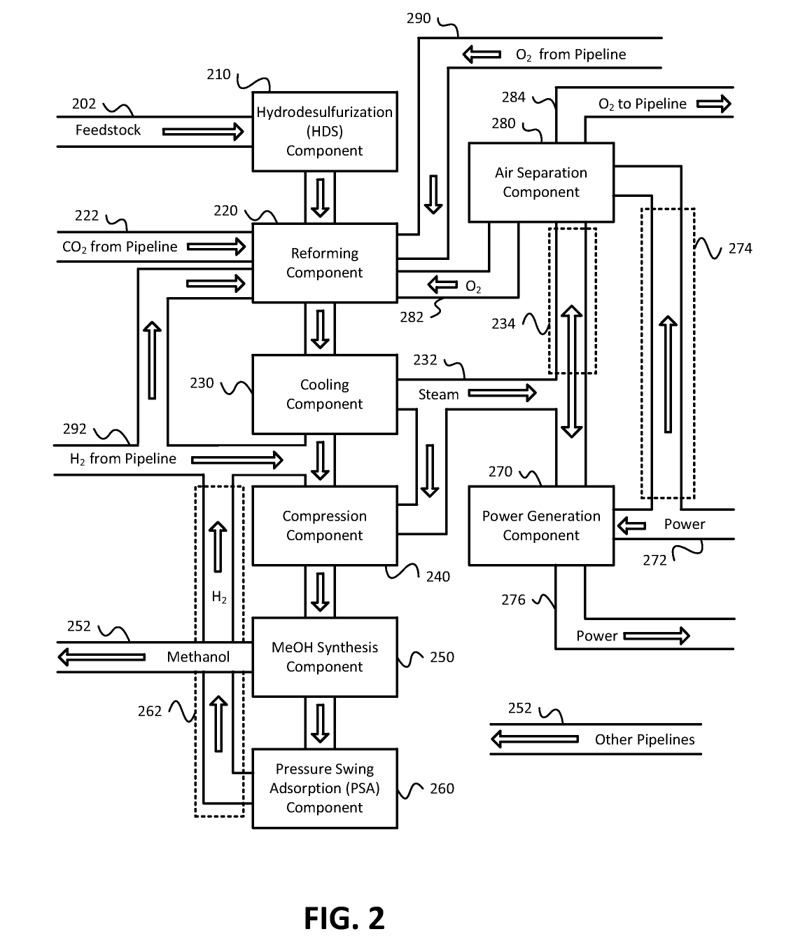

To illustrate, and referring to FIG. 2, a block diagram illustrating various configuration options for configuring a methanol production facility is shown. As shown in FIG. 2, a methanol production facility may include a desulphurization unit (e.g., a hydrodesulphurization (HDS) component 210), a reforming component 220, a cooling component 230, a compression component 240, a methanol synthesis component 250, a hydrogen recovery unit (e.g., a pressure swing adsorption (PSA) component 260), a power generation component 270, and an air separation component 280. During operation of the methanol production facility, feedstock (e.g., hydrocarbons such as methane, ethylene, ethane, propene, propane, butane, isobutane, pentane, isopentane, hexane, benzene, naptha, or another hydrocarbon), indicated as 202, is provided to the HDS component 210, and sulfur is removed from the feedstock. It is noted that in some aspects, the feedstock may be converted to methane prior to use for the generation of methanol (e.g., prior to providing the feedstock 202 to the HDS component 210). Furthermore, it is noted that the methanol production facility may utilize a feedstock comprising multiple hydrocarbons in various forms (e.g., a liquid/gas feedstock).

After removing the sulfur from the feedstock 202, the HDS component 210 provides the feedstock to the reforming component 220 to produce syngas. The reforming component 220 may be configured to generate hydrogen and carbon monoxide by heating the feedstock received from the HDS component 210. The reforming component 220 may be a steam methane reforming (SMR) component or may be an autothermal reforming (ATR) component, or a combination of the two (e.g., combined reforming). The SMR component may be more costly to construct than the ATR component, but may be more cost-effective to operate than the ATR. In some applications, the reforming component 220 may use a portion of the feedstock to generate the heat used to heat the remaining portion of the feedstock, which may reduce the amount of methanol produced per unit of feedstock received at the methanol production facility.

Because the feedstock output from the reforming component 220 may be very hot, it is passed to the cooling component 230 to be cooled. During the cooling, steam may be generated (e.g., as the hot syngas is cooled). In an embodiment not shown, the feedstock can be preheated against the hot syngas. The steam may be provided to other components to facilitate operations of the other components or to assist with the operation of the other components. For example, as indicated at 232, the steam may be provided to the power generation unit 270 which may produce electricity using the steam. This may reduce an amount of power received from external sources, indicated at 272. During operations of the cooling component 230 and the compression component 240, the hot syngas coming from the reforming component 220 may be cooled and compressed before being sent to the methanol synthesis component 250.

The methanol synthesis component 250 is configured to convert the cooled, compressed syngas into methanol. In an embodiment not shown, a raw methanol stream is produced by reacting the syngas stream over a catalyst bed. The raw methanol stream may include methanol, water, carbon monoxide, carbon dioxide, hydrogen, and methane. The raw methane can then be sent to a liquid/gas separator to remove dissolved offgases (e.g., CO, CO2, H2, and CH4) from the raw methanol. The resulting stream can then be sent to a distillation system configured to separate water from the methanol, resulting in a methanol stream and a water stream. As such, the methanol synthesis component 250 may be configured to provide the methanol to a pipeline or other destination, such as a storage facility (not shown in FIG. 2), as indicated at 252, and provide the offgases to the PSA component 260. The PSA component 260 may be configured to separate hydrogen from the offgases received from the methanol synthesis component 250. The hydrogen may be provided to the compression component 240 to increase the rate of reaction and the rate of production of methanol.

The air separation component 280 may be configured to generate oxygen, which may be provided to the reforming component 220, where it is used during the reforming. As shown in FIG. 2, the air separation component 280 may be configured to receive at least a portion of its operational power from the external sources, indicated at 272. Additionally, the air separation component 280 may include an internal power source. The internal power source of the air separation component 280 may generate a portion of the operational power for the air separation component 280 using a portion of the steam produced by the cooling component 230, as indicated at 232.

Referring back to FIG. 1, the electronic device 120 may analyze the proposed configuration for the methanol facility to identify a type of each of the plurality of components and the requirements (e.g., requires oxygen during operation) and/or functions (e.g., extracts hydrogen) of each of the plurality of components. For example, the electronic device 120 may determine a type (e.g., SMR or ATR) of a reforming component (e.g., the reforming component 220 of FIG. 2) indicated in the proposed configuration, a requirement (e.g., oxygen) of the reforming component, and a function of the reforming component (e.g., generate hydrogen and carbon monoxide). As another example, the electronic device 120 may determine a type (e.g., internal power supply vs. external power supply, etc.) of an air separation component (e.g., the air separation component 280 of FIG. 2) indicated in the proposed configuration, a requirement (e.g., power) of the air separation component, and a function (e.g., produce oxygen) of the air separation component. In an aspect, the type, requirement, and function of each of the plurality of components may be included in the request 102. In an additional or alternative aspect, the electronic device 120 may determine the type, requirement, and function of each of the plurality of components based on production facility configuration data 148 stored at the database 140.

Based on the analysis of the proposed configuration, the electronic device 120 may estimate a first cost corresponding to an amount of capital expenditure required to construct the methanol production facility using the proposed configuration, and may estimate a second cost corresponding to operational expenses for operating the methanol production facility configured according to the proposed configuration over a period of time (e.g., 1 year, 5 years, 10 years, etc.). In an aspect, the period of time may be determined from information included in the request 102.

After analyzing the proposed configuration of the methanol production facility, the electronic device 120 may determine an alternative configuration of the methanol production facility. The alternative configuration may be different from the proposed configuration. For example, the alternative configuration may omit one or more of the plurality of components indicated in the proposed configuration. To illustrate, based on the requirements of the plurality of components, the electronic device 120 may identify resources accessible to a proposed location for the methanol production facility. The proposed location may be indicated in the request 102.

The resources may be determined based on geographic data, pipeline data, other data, or a combination thereof. In an aspect, the geographic data may be stored at the database 140 as geographic data 144 and the pipeline data may be stored at the database 140 as pipeline data 146. The geographic data may include topology data representative of a topology of the proposed location for the methanol production facility. The pipeline data 146 may include information identifying a plurality of existing pipelines, and may indicate a resource provided by each of the plurality of existing pipelines. The identified resources may be accessible from at least one source external to the methanol production facility, such as operators or providers of the pipelines, and each of the identified resources may be utilized in the production of methanol at the methanol production facility using the proposed configuration. For example, the identified resources may include hydrogen pipelines, carbon dioxide pipelines, oxygen pipelines, methanol pipelines, feedstock pipelines, or other pipelines that are accessible to the proposed location for the methanol production facility. Additional examples of resources that may be provided by pipelines and that may be identified using the pipeline data 146 include water pipelines, steam pipelines, nitrogen pipelines, air pipelines, etc.

In an aspect, the electronic device 120 may determine a distance between each of the one or more pipelines and the proposed location, and determine whether a distance between the proposed location and each of the one or more pipelines is within a threshold distance. The distance may correspond to a distance at which it is not economically feasible to construct infrastructure for tapping into the pipelines from the proposed location, or a distance at which transmission of a resource provided by the pipeline is subject to pressure drops, or some other factor. In addition to identifying resources accessible via the pipelines, the electronic device 120 may determine whether other resources, such as water, roads, etc., are proximate to the proposed location.

The electronic device 120 may designate pipelines within the threshold distance as accessible pipelines, and may designate resources provided by the accessible pipelines as the resources accessible to the proposed location. The electronic device 120 may determine, based on the proposed configuration information or information stored at the database 140, whether the resources accessible to the proposed location include all of the resources utilized in producing methanol at the methanol production facility using the proposed configuration. In an aspect, at least one of the resources utilized in the production of methanol at the methanol production facility using the proposed configuration may be generated by a component indicated by the proposed configuration, such as hydrogen produced by the PSA component of FIG. 2 or oxygen produced by the air separation component 280 of FIG. 2.

The electronic device 120 may identify a subset of the accessible pipelines. The subset of pipelines may include a single pipeline selected from among the accessible pipelines for each resource utilized in the production of methanol at the methanol facility using the proposed configuration (or for each resource utilized in the production of methanol that is also included in the resources accessible to the proposed location). In an aspect, the electronic device 120 may estimate an infrastructure cost for each pipeline of the accessible pipelines. For a particular pipeline of the set of pipelines, the infrastructure cost may correspond to a cost to build infrastructure (e.g., a pipeline) from the proposed location to the particular pipeline to provide the proposed location with access to a resource included in the second set of resources. Each pipeline included in the subset of pipelines may be associated with a lowest infrastructure cost for a particular resource of the resources accessible to the proposed location. In an aspect, the infrastructure costs for each pipeline in the subset of pipelines may be accounted for by the electronic device 120 when generating the third cost (e.g., CapEx associated with constructing the methanol production facility using the alternative configuration).

The electronic device 120 may determine whether all resources generated by one or more of the plurality of components of the proposed configuration may be provided by the subset of pipelines. For example, let “X” be the set of resources generated by components of the proposed configuration (e.g., oxygen by the air separation component 280 of FIG. 2, hydrogen by the PSA component 260 of FIG. 2, etc.) and let “Y” be the set of resources provided by the subset of the accessible pipelines. The electronic device 120 may determine whether all resources generated by one or more of the plurality of components of the proposed configuration may be provided by the subset of pipelines by evaluating whether for each resource xᵢ in the set of resources “X” there is a corresponding resource y, included in the set of resources Y, where the set of resources “X” includes N resources, N>0, xᵢ is an i-th resource included in the set or resources “X,” i=1 to N, and where the set of resources “Y” includes M resources, M≦0, yⱼ is an j-th resource included in the set or resources “Y,” j≧0. When at least one resource xᵢ has a corresponding resource yᵢ (e.g., M>0), the electronic device 120 may proceed to determine the alternate configuration.

Determining the alternate configuration may include determining, based on the resources provided by the subset of pipelines, a first set of components that may be removed from the proposed configuration of the methanol production facility (e.g., because the resources generated by the first set of components may be provided via the subset of pipelines), and may include determining, based on the resources provided by the subset of pipelines, a second set of components that may not be removed from the proposed configuration (e.g., because those components do not generate a resource that may be provided by a particular pipeline or because those components do not generate a resource). The first set of components may be removed from the configuration of the methanol production facility in the alternative configuration while the second set of components are retained in the alternative configuration. Thus, when the methanol production facility is constructed according to the alternate configuration, the resources generated by the first set of components may be provided by the subset of pipelines, as opposed to generated by one or more components of the methanol production facility.

To illustrate, and with reference to FIG. 2, the electronic device 120 may determine that the subset of pipelines includes a feedstock pipeline, an oxygen pipeline, a hydrogen pipeline, and/or other pipelines (e.g., a carbon dioxide pipeline, a carbon monoxide pipeline, a water pipeline, an air pipeline, a nitrogen pipeline, a methanol pipeline, etc.). The electronic device 120 may estimate an infrastructure cost associated with building infrastructure to tap into each pipeline of the subset of pipelines. For example, the electronic device 120 may estimate an infrastructure cost associated with building infrastructure to tap into the oxygen pipeline and provide oxygen to the methanol production facility, as indicated at 290, and may estimate an infrastructure cost associated with building infrastructure to tap into the hydrogen pipeline and provide hydrogen to the methanol production facility, as indicated at 292. The electronic device 120 may determine the estimated infrastructure cost for each pipeline based on a distance between the proposed location (or an alternative location) for the methanol production facility and each of the respective pipelines included in the subset of pipelines. As the distance increases, the costs associated with building the infrastructure increase. In an aspect, the electronic device 120 may determine whether the distance exceeds a threshold distance. If the distance exceeds the threshold distance, boosters may be necessary to provide the resources to the methanol production facility in required quantities and with adequate delivery pressure. If boosters are required, the infrastructure costs may increase further. Providing oxygen to the methanol production facility via the pipeline may eliminate the need to include the air separation component 280, which may substantially reduce the CapEx required to construct the methanol production facility according to the alternate configuration.

An additional benefit of eliminating the air separation component 280 may be a reduced amount of power provided from external sources. For example, by eliminating the air separation component 280, power supplied to the air separation component 280 from an external source may also be eliminated, as indicated at 274. Furthermore, the steam, indicated at 234, that may have been provided to the air separation component 280, may now be provided in greater quantities to the power generation component 270, increasing an amount of power generated at the power generation component 270 and reducing the amount of energy received from the external sources. As indicated at 276, excess power (e.g., power exceeding the requirements of the components of the methanol production facility) generated by the power generation component 270 may be sold, thereby creating an additional source of revenue for the methanol production facility. A greater quantity of steam may also be provided to the compression component 240, which may reduce the operating costs of the compression component 240.

When the reforming component 220 is an SMR component or includes both the SMR component and an ATR component, a carbon footprint (e.g., carbon dioxide emissions) of the methanol production facility, and a rate of methanol production for the methanol production facility may be affected by a size of the SMR component. To illustrate, as a size of the SMR component increases, the rate of methanol production increases, and as the size of the SMR component decreases, the rate of methanol production decreases. Stated another way, larger SMR components produce a larger volume of carbon monoxide and hydrogen relative to smaller SMR components, thereby increasing the rate at which the methanol production facility generates methanol (e.g., by subsequently reacting the carbon monoxide and hydrogen). In addition to producing carbon monoxide and hydrogen, the SMR component produces offgases, such as carbon dioxide. The volume of offgases produced by the SMR component increases and/or decreases relative to the size of the SMR. The offgases produced by the SMR component are often flared from the methanol production facility. Thus, the carbon footprint of the methanol production facility increases as the size of the SMR component increases due to the increased production of offgases (e.g., carbon dioxide) and decreases as the size of the SMR component decreases.

Providing carbon dioxide and hydrogen to the methanol production facility via pipelines, as indicated at 222 and 292 respectively, may reduce a carbon footprint of the methanol production facility relative to the size of the reforming component (e.g., the size of the SMR component) while increasing a rate of methanol production for the methanol production facility. For example, the hydrogen provided via the pipeline may be reacted with the carbon dioxide provided by the pipeline to generate additional methane, which may the SMR component may transform into additional carbon monoxide and hydrogen, which may increase an amount of methanol produced by the methanol production facility without increasing the size of the SMR component and without increasing the carbon footprint of the methanol production facility. Additionally, when the carbon dioxide and the hydrogen are provided to the methanol production facility, the operational reliability of the methanol production facility may be increased. For example, if a disruption (e.g., pipeline repairs, pipeline maintenance, etc.) occurs to the pipeline that provides the feedstock to the methanol production facility, production of methanol may continue using only the carbon dioxide and the hydrogen provided via the pipelines, as indicated as 222 and 292, respectively. Producing methanol (or supplementing the production of methanol) using the hydrogen and the carbon dioxide provided via the pipelines may increase the OpEx of the methanol production facility. It is noted that FIG. 2 illustrates providing the hydrogen and the carbon dioxide to the reforming component 220 via the pipelines for purposes of illustration, rather than by way of limitation, and that in additional or alternative aspects, the hydrogen and the carbon dioxide may be provided to other components of the methanol production facility via the pipelines, such as the compression component 240 and/or methanol synthesis component 250.In addition to reducing the carbon footprint of the methanol production facility by importing carbon dioxide and hydrogen, as opposed to increasing the size of the reforming component 220, the importing of carbon dioxide may reduce the carbon footprint of other facilities as well. For example, another refinery or facility that generates carbon dioxide during operation may provide its carbon dioxide to the methanol production facility via the pipeline, rather disposing of the carbon dioxide through flaring. Thus, the carbon footprint of locations other than the methanol production facility may also be reduced.

As another example, providing the hydrogen to the methanol production facility via the hydrogen pipeline may eliminate the need to include the PSA component 260, further reducing the CapEx required to construct the methanol production facility according to the alternate configuration. As shown in FIG. 2, the hydrogen provided by the PSA component, indicated at 262, may be replaced with the hydrogen provided via the pipeline, as indicated at 292. Thus, it can be seen that determining the alternate configuration for the methanol production facility may reduce the CapEx for constructing the methanol production facility relative to the CapEx associated with the proposed configuration. In some aspects, the reduction in CapEx created by the alternate configuration may exceed twenty five percent (25%), which may make it easier for an entity to acquire financing for and/or authorizing expenditures for constructing the methanol production facility.

However, providing the oxygen and the hydrogen to the methanol production facility via the pipelines, as indicated at 290, 292, respectively, may increase the OpEx of the methanol production facility relative to the OpEx associated with the proposed configuration. The increased OpEx may be caused by the purchase of the hydrogen and the oxygen from the pipelines. Thus, the electronic device 120 may estimate a cost to purchase the resources from one or more operators (e.g., operators of the oxygen and hydrogen pipelines). The OpEx associated with the alternate configuration may be determined based at least in part on the cost to purchase the resources from the one or more operators. It is estimated that providing resources to the methanol production facility using pipelines, as described above, may increase OpEx for the methanol production facility by five percent (5%), which is relatively low compared to the twenty five percent (25%) reduction in CapEx according to the alternate configuration.

An additional benefit of providing resources to the methanol production facility via the pipelines is fixed costs. For example, resources provided via the pipelines are typically sold at a fixed cost per unit of the resource for a term of time according to a contract. In an aspect, the electronic device 120 may predict the OpEx for the proposed configuration and the alternative configuration. For example, and with reference to FIG. 1, the electronic device 120 may access historical price data 142 stored at the database 140. The historical price data 142 may include information associated with a cost of resources provided by one or more pipelines, including one or more of the accessible pipelines, price per unit distance (e.g., price per meter, half-mile, mile, kilometer, etc.) for different types of pipelines (e.g., pipelines of different diameters, pressures, etc.) which may be required for various configurations, resources, applications (e.g., methanol production, oil refining, etc.), or other reasons. The information included in the historical price data 142 may be collected from various external sources, such as operators of pipelines, entities that install pipelines, etc., and/or by an operator of the electronic device 120. In an aspect, the historical price data 142 may be used in conjunction with information obtained from the production facility configuration data 148 to estimate the OpEx for the proposed configuration and the alternative configuration over a period of time (e.g., a term of months, years, etc.). For example, the historical price data 142 may indicate an amount of a particular resource consumed or a rate of the particular resource consumed during production of methanol at a desired methanol output rate, where the amount or the rate of the particular resource consumed increases as the output rate increases. This information may be used to estimate a cost to purchase the resources for production of methanol at the methanol production facility from the pipelines over a period of time, or over multiple periods of time (e.g., 1 year, 3 years, and 5 years). Additionally, this information may be used to estimate an internal rate of return and to predict an amount of time required to realize a profit from the production of the methanol at the methanol production facility. Similar information may be predicted for the proposed configuration as well.

The electronic device 120 may estimate a time frame for upgrading the methanol production facility from the alternative configuration to the proposed configuration. For example, although providing a lower CapEx cost during construction of the methanol production facility, at some point the operator may desire to reduce the OpEx associated with the alternative configuration by upgrading the methanol production facility to include one or more of the components of the proposed configuration that were omitted from the alternate configuration. This may include construction of an air separation component or a PSA component, or both. This may provide additional benefits to the operator of the methanol production facility. For example, the air separation component may include a plurality of sub-components that each generate a quantity of oxygen, and more sub-components would cause the air separation component as a whole to generate more oxygen while less sub-components would cause the air separation component to produce less oxygen. Thus, for scalable components, such as the air separation component, the operator may incrementally add sub-components to increase the amount of the resource generated at the methanol production facility, thereby proportionately reducing the amount of the resource purchased from one of the pipelines. The electronic device 120 may determine a schedule for adding each of the one or more components omitted from the alternative configuration, and may further determine whether the components should be incrementally upgraded and provide a recommendation as to a time table for such upgrades.

When one of the components omitted from the alternative configuration of the methanol production facility is a scalable component including a plurality of sub-components, the electronic device 120 may determine whether to add all of the plurality of sub-components included in the scalable component at once, or to upgrade the scalable component incrementally (e.g., adding one or more sub-components of the plurality of sub-components at a time). Upgrading the scalable component incrementally includes adding a first sub-component of the plurality of sub-components at a first time and adding a second sub-component of the plurality of sub-components at second time subsequent to the first time. In response to a determination to upgrade the scalable component incrementally, the electronic device 120 may generate a time table for incrementally upgrading the scalable component during the period of time. The time table may be included in the schedule. Additionally, an estimated OpEx associated with the scalable component may decrease as the scalable component is added according to the schedule (e.g., as the scalable component produces more of a resource with each sub-component addition thereby reducing pipeline resource utilization). The OpEx associated with the alternative configuration of the methanol production facility may account for changes in the estimated OpEx associated with adding the scalable component according to the time table.

As the components are subsequently constructed and/or incrementally upgraded at the methanol production facility, the amount of resources purchased from the pipelines may be reduced or eliminated. For example, after a number of years of operation, as proposed by the electronic device 120, the operator of the methanol production facility may construct an air separation component operable to generate fifty percent (50%) of the oxygen required for the methanol production facility. The pipelines may provide the remaining fifty percent (50%).

Furthermore, if one of the components, such as the air separation component, fails or otherwise needs to be turned off (e.g., for repairs or cleaning), the methanol production facility may remain operational by increasing an amount of a resource received via the pipeline and receiving the required resources from the pipeline. Thus, it can be seen that connecting the methanol production facility to the pipelines may increase the operational reliability of the methanol production facility. It may also increase the safety of operating the methanol production facility, as shutting down and/or starting up the methanol production facility is considered by many to be one of the riskiest aspects of operating the methanol production facility. In an aspect, the electronic device 120 may be operable to predict an amount of time that the methanol production facility will be down (e.g., due to failed components that produce the resources required to produce methanol) when configured according to the proposed configuration (e.g., without connections to the pipelines) and an amount of time that the methanol production facility will be down when configured according to the alternative configuration (e.g., with connections to the pipelines), and, based on this information, the electronic device 120 may estimate difference between an amount of methanol produced by the methanol production facility using the proposed configuration and the alternative configuration. The electronic device 120 may also generate a risk analysis based on a predicted number of times that the methanol production facility will be turned on and off over a period of time when constructed using the proposed configuration.

In some aspects, the electronic device 120 may provide scheduling information for upgrading the methanol production facility to be self-sufficient (e.g., all resources provided by the components of the methanol production facility). For example, the electronic device 120 may generate information indicating that after 3 years of operating the methanol production facility according to the alternate configuration, an air separation component including one or more sub-components may be constructed. With this new configuration, the amount of resources provided by the pipelines may be reduced. In some aspects, the upgrading of the components may result in the components producing slightly more resources than are required for producing methanol at the methanol production facility. For example, an air separation component including a first number of sub-components may not provide one hundred percent (100%) of the oxygen required by the methanol production facility, but adding an additional sub-component may cause the air separation component to generate one hundred and five percent (105%) of the oxygen required by the methanol production facility. The additional five percent (5%) of the oxygen may be routed to the oxygen pipeline where it may be sold. The electronic device 120 may determine whether adding or upgrading the components of the methanol production facility according to the scheduling information will result in production of excess resources (e.g., oxygen, hydrogen, power, etc.), and may estimate an amount of revenue that may be received by the operator of the methanol production facility from the sale of the excess resources.

In an aspect, the methanol production facility, when configured according to the alternative configuration, may produce at least a same amount of methanol per unit of feedstock as the methanol production facility when configured according to the proposed configuration. In additional or alternative aspects, the methanol production facility, when configured according to the alternative configuration, produces a greater amount of methanol per unit of feedstock than an amount of methanol per unit of feedstock produced by the methanol production facility when configured according to the proposed configuration. For example, the proposed configuration may include a component that consumes a portion of each unit of feedstock to generate heat for transforming a remaining portion of the feedstock into carbon monoxide and hydrogen. When that component is omitted from the alternative configuration, the entirety of each unit of feedstock may be transformed into carbon monoxide and hydrogen. Thus, according to some aspects, the alternative configuration may generate a greater amount of methanol per unit of feedstock than the proposed configuration.

In some aspects, constructing the methanol production facility according to an alternative configuration may expedite production of methanol relative to the proposed configuration. For example, some governmental regulations require an operator of a facility, such as methanol production facility, to obtain a permit when carbon dioxide emissions of the facility exceed a threshold amount. The carbon dioxide emissions of a methanol production facility configured according to an alternative configuration determined by the device 120 may be reduced to below the threshold level, enabling an operator of the methanol production facility to bypass the permitting process, which could take a year or longer to complete. Thus, an extra year of methanol production may be gained by configuring the methanol production facility according to the alternative configuration.

In an aspect, the electronic device 120 may determine whether a size of a reforming component (e.g., the reforming component 220 of FIG. 2) may be increased without exceeding the threshold level of carbon dioxide emissions. For example, the proposed configuration may indicate that the reforming component includes an SMR component having a first size. The electronic device 120 may estimate an amount of carbon dioxide emissions for the methanol production facility configured according to the proposed configuration (e.g., having a reforming component that includes the SMR component of the first size), and may determine whether the estimated amount carbon dioxide emissions is below the threshold level. In response to a determination that the estimated amount carbon dioxide emissions for the methanol production facility according to the proposed configuration is below the threshold level, the electronic device 120 may determine whether the identified resources accessible to the methanol production facility include carbon dioxide (e.g., the carbon dioxide pipeline 222 of FIG. 2) and hydrogen (e.g., the hydrogen pipeline 292 of FIG. 2). In response to a determination that the identified resources include carbon dioxide and hydrogen, the electronic device 120 may determine whether an SMR component having a second size that is larger than the first size may be included in an alternative configuration without increasing the carbon dioxide emissions of the methanol production facility (e.g., by generating a portion of the methanol using the carbon dioxide and hydrogen provided via the pipelines). Thus, the rate of methanol production for the methanol production facility according to the alternative configuration may be greater (e.g., because of the larger SMR component) than a rate of methanol production for the methanol according to the proposed configuration without increasing the carbon dioxide emissions of the methanol production facility. Thus, the alternative configuration may enable the operator to recoup the costs of constructing the methanol production facility more quickly, and may increase the internal rate of return (IRR) for the methanol production facility.

In response to a determination that the estimated amount carbon dioxide emissions for the methanol production facility according to the proposed configuration exceed the threshold level, the electronic device 120 may determine whether the identified resources accessible to the methanol production facility include carbon dioxide (e.g., the carbon dioxide pipeline 222 of FIG. 2) and hydrogen (e.g., the hydrogen pipeline 292 of FIG. 2). In response to a determination that the identified resources include carbon dioxide and hydrogen, the electronic device 120 may determine whether carbon dioxide emissions for the methanol production facility according to an alternative configuration including a reforming component (e.g., the reforming component 220 of FIG. 2) having the SMR component of the first size may be reduced below the threshold level (e.g., by generating a portion of the methanol using the carbon dioxide and hydrogen provided via the pipelines). Thus, the rate of methanol production for the methanol production facility according to the alternative configuration may be equal to the rate of methanol production for the methanol according to the proposed configuration while reducing the carbon dioxide emissions of the methanol production facility to below the threshold level, enabling the operator of the methanol production facility to begin methanol production one year earlier. This may enable the operator to recoup the costs of constructing the methanol production facility more quickly, and may increase the internal rate of return (IRR) for the methanol production facility. Additionally, the reduced carbon emissions provided by the alternative configuration of the methanol production facility may cause the operator to accrue excess carbon credits, which may be sold, generating another revenue source for the operator of the methanol production facility.

In an aspect, the electronic device 120 may determine a first amount of carbon dioxide emissions based on the proposed configuration for the methanol production facility, and determine a second amount of carbon dioxide emissions based on the alternative configuration for the methanol production facility. The second amount of carbon dioxide emissions may be lower than the first amount of carbon dioxide emissions. The report 104 may include information representative of the first amount of carbon dioxide emissions and the second amount of carbon dioxide emissions. In an additional or alternative aspect, the electronic device 120 may determine a first amount of carbon credits based on the first amount of carbon dioxide emissions, and determine a second amount of carbon credits based on the second amount of carbon dioxide emissions. The electronic device 120 may determine a difference between the first amount of carbon credits and the second amount of carbon credits, and may offset the OpEx associated with the alternative configuration based on the difference between the first amount of carbon credits and the second amount of carbon credits. If there is an excess amount carbon credits, the operator of the methanol production facility may sell the excess carbon credits. Thus, the alternative configuration may enable the operator to recoup the costs of constructing the methanol production facility more quickly, and may increase the internal rate of return (IRR) for the methanol production facility.

In an aspect, the electronic device 120 may identify one or more alternative locations (e.g., locations other than the proposed location) for the methanol production facility. The alternative locations may be determined based on an analysis of the geographic data 144 and the pipeline data 146. For example, the electronic device 120 may identify one or more alternative locations where a greater number of the resources are accessible relative to the proposed location. Stated another way, each of the alternative locations may be accessible to a greater number of resources utilized in the production of methanol than the proposed location. The resources accessible to the one or more alternative locations may include resources required for production of methanol, such as a feedstock source (e.g., the feedstock 202 of FIG. 2), a power source (e.g., the power pipeline 272 of FIG. 2), oxygen (e.g., the oxygen pipeline 290 of FIG. 2), and sources for other resources (e.g., the other pipelines 252 of FIG. 2). The resources accessible to the one or more alternative locations may also include resources that are not required to produce methanol, but that may be utilized during the production of methanol, such as a hydrogen source (e.g., the hydrogen pipeline 292 of FIG. 2) and a carbon dioxide source (e.g., the carbon dioxide pipeline 222 of FIG. 2).

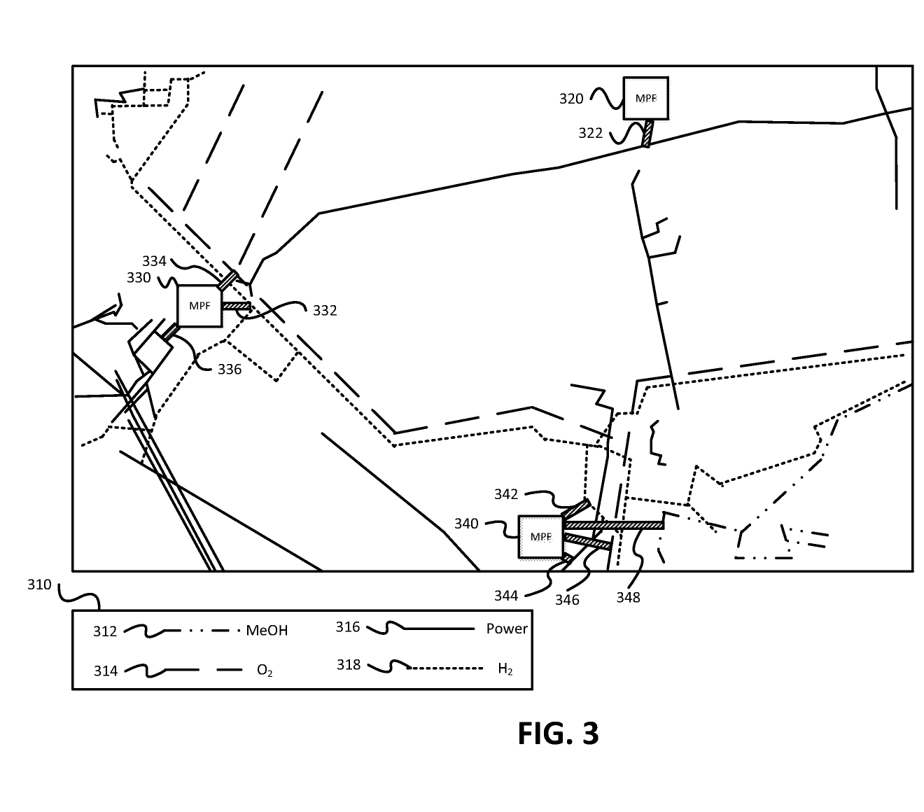

To illustrate, and referring to FIG. 3, a diagram illustrating exemplary aspects of determining an alternative location for constructing a methanol facility is shown. In FIG. 3, a plurality of pipelines and a plurality of potential methanol production facility locations are shown. As indicated by the legend 310, the plurality of pipelines include methanol pipelines 312, oxygen pipelines 314, power pipelines 316, and hydrogen sources 318. The methanol pipelines may be used to transport methanol from a methanol production facility to a remote location, such as a storage facility or other type of facility. It is noted that the pipelines shown in FIG. 3 are for purposes of illustration, rather than by way of limitation, and that other pipelines carrying other resources may be accounted for during operations for determining alternative configurations and locations for a methanol production facility according to aspects of the present disclosure. For example, as described above, the other resources may include sources for feedstock, such as natural gas wells, natural gas and other hydrocarbon pipelines, etc.), carbon dioxide pipelines, water pipelines, air pipelines, nitrogen pipelines, etc.). The plurality of potential locations includes a proposed location 320 (e.g., a location proposed in the request 102 of FIG. 1), a first alternative location 330, and a second alternative location 340.

In FIG. 3, a set of accessible pipelines for the proposed location 320 includes power pipelines, as indicated at 322, a set of accessible resources for the first alternative location 330 includes power pipelines, as indicated at 336, hydrogen pipelines, as indicated at 334, and oxygen pipelines, as indicated at 332. Additionally, a set of accessible resources for the second alternative location 340 may include power pipelines, as indicated at 344, hydrogen pipelines, as indicated at 342, oxygen pipelines, as indicated at 346, and methanol pipelines 348. As can be seen in FIG. 3, the proposed location 320 has access to one resource (e.g., power), the first alternative location 330 has access to three resources (e.g., power, hydrogen, and oxygen), and the second alternative location 340 has access to four resources (e.g., power, hydrogen, oxygen, and the methanol pipeline).

In an aspect, the proposed location 320 and the first alternative location 330 may each be within a threshold distance of a methanol pipeline, however the cost of constructing the infrastructure to access the respective methanol pipelines may be greater than the cost of the infrastructure to access the methanol pipeline indicated at 348. As will be appreciated, constructing the methanol production facility at the proposed location 320 according to the proposed configuration may require the highest CapEx. However, constructing the methanol production facility at the proposed location 320 according to an alternative location (e.g., without a power generation component, or with a power generation component that produces less power than in the proposed configuration), while resulting in a slightly lower CapEx using the proposed configuration, may not provide a significant enough reduction in CapEx to substantiate construction of the methanol production facility or construction of the methanol production facility according to the alternative configuration.

Constructing the methanol production facility at the first alternative location 330 according to a second alternative configuration (e.g., by omitting the air separation component and the PSA component, and receiving at least a portion of the operational power for the methanol production facility from the power pipeline) may result in a significant decrease in the CapEx, which may make construction of the methanol production facility more affordable. Furthermore, constructing the methanol production facility at the second alternative location 340 may result in an even more significant decrease in CapEx (e.g., by omitting the air separation component and the PSA component, and by receiving at least a portion of the operational power for the methanol production facility from the power pipeline, and by having a lower infrastructure cost for accessing the methanol pipeline). Thus, an electronic device (e.g., the electronic device 120 of FIG. 1) may generate information proposing construction of the methanol production facility at the second alternative location 340. The electronic device may also generate information associated with the CapEx and OpEx for each location and configuration, and may generate other information, such as upgrade schedules, internal rates of return (IRR), etc. for each location and configuration.

In an aspect, the electronic device 120 may generate a map illustrating the proposed location and the one or more identified alternative locations for the methanol production facility and may identify geographic coordinates/boundaries for the methanol production facility. The map may also identify the resources available to each of the locations and may indicate, for each of the locations, a length of a shortest pipeline to each available resource, and a direction from each of the locations to the nearest available resource pipeline. The map may further indicate whether pipelines for any of the locations require boosters to provide adequate delivery pressure for the resources provided by the pipelines. In an additional or alternative aspect, the electronic device 120 may determine the alternative locations for the methanol production facility by locating alternative sources for feedstock for the methanol production facility, or by determining whether an alternative source for feedstock is accessible from a proposed location for the methanol production facility.

Referring back to FIG. 1, the electronic device 120 may be configured to determine at least one additional alternative configuration of the methanol production facility. The at least one additional alternative configuration may be different from the proposed configuration and the alternative configuration. For example, the at least one additional alternative configuration may correspond to a configuration at an alternative location having access to more resources, thereby increasing the number of components that may be omitted from the methanol production facility and reducing CapEx for the at least one additional alternative configuration relative to the proposed configuration and the alternative configuration, which may correspond to configurations at a location proposed in the request 102. Alternatively or additionally, the at least one additional alternative configuration may include a second alternative configuration for the methanol production facility at the proposed location. For example, a first alternative configuration for the methanol production facility at the proposed location may not include an air separation component, and the second alternative configuration for the methanol production facility at the proposed location may include an air separation component that is operable to generate less than a full amount of oxygen required by the methanol production facility. Thus, the alternative configurations may provide different configurations across multiple locations, as described above with reference to FIG. 3, or may provide different configurations at a single location (e.g., a lowest CapEx configuration, an intermediate CapEx configuration, and a highest CapEx configuration associated with the proposed configuration).

In an aspect, the request 102 may identify a threshold IRR, and the electronic device 120 may iteratively determine different alternative configurations to identify an alternative configuration that satisfies the threshold IRR. The electronic device 120 may first determine whether different alternative configurations at the proposed location satisfy the threshold IRR. If the electronic device 120 fails to identify an alternative configuration satisfying the threshold IRR at the proposed location, the electronic device 120 may identify one or more alternative locations, as described above, and determine whether an alternative configuration satisfying the threshold IRR at one or more of the alternative locations can be identified. In an aspect, the electronic device 120 may identify the alternative locations prior irrespective of whether an alternative configuration satisfies the threshold IRR and may determine a location (e.g., the proposed location or one of the alternative locations) provides a highest IRR satisfying the threshold.

The electronic device 120 may be configured to estimate, for each determined configuration, a cost corresponding to an amount of CapEx required to construct the methanol production facility using a particular determined configuration, and may estimate, for each determined configuration, a cost corresponding to an amount of OpEx for operating the methanol production facility when configured according to each of the determined configurations. In an aspect, the CapEx and the OpEx may be estimated over a period of time. For example, the electronic device 120 may estimate CapEx and OpEx during each of a plurality of years. For the proposed configuration, a substantial majority of CapEx may be experienced during construction of the methanol production facility, which may take a year or more, whereas CapEx for the alternative configurations may be spread out over a number of years due to upgrading of the methanol production facility. The OpEx for the proposed configuration may remain relatively constant during the plurality of years, and the OpEx for the alternative configurations may begin higher than the OpEx for the proposed configuration and then incrementally converge with the OpEx for the proposed configuration during the plurality of years as the methanol plant is upgraded. The electronic device 120 may also be configured to calculate an IRR for each of the configurations of the methanol production facility.

Many of the costs associated with the OpEx fluctuate on the daily market. For example, the price of natural gas, which may be used as the feedstock for the methanol production facility, fluctuates frequently (e.g., daily/hourly). In some configurations, the cost of the feedstock may account for between eighty percent (80%) and ninety percent (90%) of the OpEx for the methanol production facility. Because the costs associated with the feedstock fluctuate frequently, the OpEx may also fluctuate frequently, leading to uncertainty of the OpEx for the methanol production facility, especially when feedstock is consumed by the reforming component to generate heat. One or more aspects of the present disclosure provide for determining alternative configurations of the methanol production facility that have a reduced amount of fluctuation in OpEx. This is because resources provide by pipelines are typically provided based on a contract price that is fixed for a period of time (e.g., a number of years, months, etc.). Transforming fluctuating costs that affect OpEx into fixed costs by using resources provided by pipelines according to an alternative configuration determined by the electronic device 120 may reduce fluctuation of OpEx for the methanol production facility during the period of time, and may increase an accuracy of estimates of the OpEx of the methanol production facility during the period of time. Other examples of resources having costs that affect the OpEx include water costs (e.g., water used to generate steam and for cooling purposes), power costs, and fuel costs (if feedstock is not used to generate heat at the reforming component).

The electronic device 120 may be configured to generate a report 104 and to send the report 104 to the client device 110 or store the report 104 at the database 140. The report 104 may include all or a portion of the information described above. For example, the report 104 may include information representative of the CapEx and OpEx for each of the proposed configurations, and information representative of a difference between the CapEx and the OpEx of the proposed configuration relative to the CapEx and the OpEx of each of the alternative configuration. Additionally, the report may identify the components from the proposed configuration that have been omitted in each of the alternative configurations. The report may include information indicating the alternative locations for the methanol production facility, and may include information indicating how soon production of methanol could begin if the methanol production facility is constructed according to each of the configurations. Other information determined by the electronic device 120, as described elsewhere herein, may also be included in the report 104, such as the scheduling information, the risk analysis information, the map information, carbon dioxide emissions information, etc.

Additionally, it is noted that, although the operations described above are based on information included in the request 102 received from the client device 110 via the network 150, other methods of receiving the information indicating the proposed configuration of the methanol production facility may be used. For example, the information may be provided to the electronic device 120 using the I/O device 128, as indicated by the request 106.

The report 104, whether generated in response to the request 102 or the request 106, may enable an entity to better evaluate the financial risk associated with construction of a methanol production facility, and to reduce the financial risk by constructing the methanol production facility according to the alternative configuration. Additionally, as explained above, constructing the methanol production facility according to the alternative configuration may increase the operational reliability and the safety of the methanol production facility. Constructing the methanol production facility according to the alternative configuration may also reduce carbon dioxide emissions of the methanol production facility and other locations (e.g., locations providing carbon dioxide to the carbon dioxide pipeline), as described above. Further, it is noted that, although described with reference to construction of a methanol production facility, the operations of the system 100 may readily be adapted for other types of refineries (e.g., gasoline refineries) or facilities that utilize resources that may be generated by components of a facility or by pipelines.

It is further noted that, although FIGS. 1-3 have been described as determining alternative configurations for the methanol production facility where components are omitted, in an aspect, the electronic device may determine alternative configurations in which the components are present, but are provided and operated by a third party (e.g., an entity different from the operator of the methanol production facility). For example, the electronic device 120 may determine an alternative configuration in which an air separation component (e.g., the air separation component 280 of FIG. 2) and/or a pressure swing absorption component (e.g., the pressure swing absorption component 260 of FIG. 2) is provided by a third party who then couples then provides the oxygen and/or hydrogen, respectively, to the methanol production facility. In such alternative configurations, the air separation component and/or the pressure swing absorption component operated by the third party may be located at or next to the location of the methanol production facility, but may be operated by the third party independent of the methanol production facility. The resources generated by the air separation component and/or the pressure swing absorption component located at or next to the location of the methanol production facility may be considered as being provided by pipelines.

In such alternative configurations, the third party incurs the costs for constructing the air separation component and/or the pressure swing absorption component. Additionally, because the air separation component and/or the pressure swing absorption component are located at or next to the methanol production facility, the pipelines to access the resources generated by the by the air separation component and/or the pressure swing absorption component may be significantly shorter than pipelines constructed to access resources provided by pipelines in remote locations (e.g., locations that are not at or next to the methanol production facility). Thus, in some alternative configurations, the CapEx associated with constructing the methanol production facility may be reduced by a greater amount by utilizing pipelines to third party components located at or next to the methanol production facility instead of pipelines to access resources provided by pipelines in remote locations (e.g., because of lower infrastructure costs for constructing the shorter pipelines).

However, alternative configurations utilizing pipelines to third party components located at or next to the methanol production facility may not provide all of the advantages provided by using pipelines to access resources provided in remote locations. For example, because the output (e.g. oxygen) of the air separation component located at or next to the location of the methanol production facility is considered the pipeline, if the air separation component is shut down for repairs, maintenance, etc., the pipeline and the methanol production facility are also shut down. Thus, the increased operational reliability described above may be lost when the pipelines providing the resources to the methanol production facility are provided from outputs of on-site components operated by a third party. As another example, the components operated by the third party may generate carbon dioxide emissions, which may increase a carbon footprint of the methanol production facility and may affect a size of the reforming component that may be used, or reduce a number of carbon credits received by the operator of the methanol production facility.

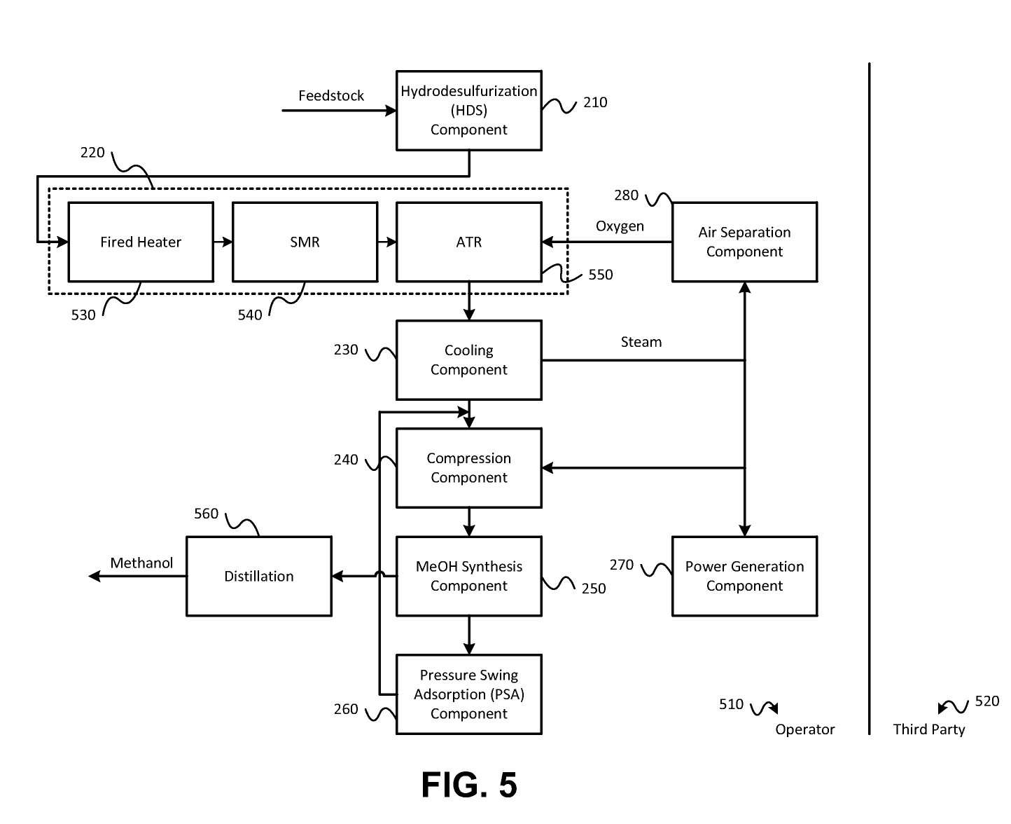

In an aspect, the third party may be an operator of the electronic device 120. In an additional or alternative aspect, the third party may be entity that is distinct from the operator of the electronic device 120. In additional or alternative aspects, the alternative configurations determined by the electronic device 120 may include pipelines carrying resources generated by on-site components operated by the third party, and pipelines carrying resources generated by components remote from the location of the methanol production facility. Thus, the electronic device 120 provides a robust platform for determining a configuration of a methanol production facility that provides a reduced CapEx and that may reduce a carbon footprint of the methanol production facility. Additional exemplary aspects of various alternative configurations of a methanol production facility are described below with reference to FIGS. 5-8.

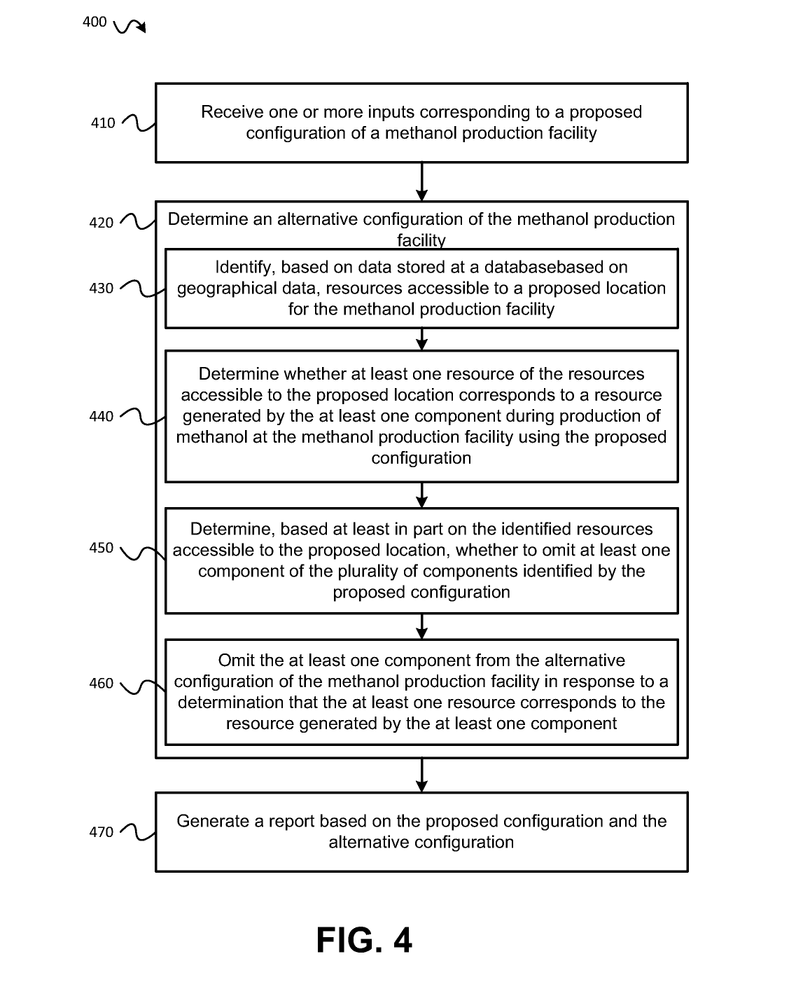

Referring to FIG. 4, a flow chart illustrating exemplary aspects of a method for determining a configuration of a methanol production facility is shown as a method 400. In an aspect, method 400 may be performed by the electronic device 120 (e.g., by the processor 122 executing the instructions 130 of FIG. 1). At 410, the method 400 includes receiving one or more inputs corresponding to a proposed configuration of a methanol production facility. In an aspect, the one or more inputs may be included in the request 102 or the request 106 of FIG. 1. The proposed configuration may identify a plurality of components utilized to produce methanol at the methanol production facility when configured according to the proposed configuration. At 420, the method 400 includes determining an alternative configuration of the methanol production facility. The alternative configuration may be different from the proposed configuration.

As shown in FIG. 4, determining the alternative configuration may include, at 430, identifying, based on data stored at a database, resources accessible to a proposed location for the methanol production facility. The proposed location may be included in the one or more inputs. In an aspect, the database may be the database 140 of FIG. 1, and the data stored at the database may include the historical price data 142 of FIG. 1, the geographic data 144 of FIG. 1, the pipeline data 146 or FIG. 1, and the production facility configuration data 148 of FIG. 1. The identified resources may be accessible from at least one source external to the methanol production facility, such as a pipeline. The identified resources may be utilized to produce methanol at the methanol production facility using the proposed configuration. At 440, determining the alternative configuration includes determining whether at least one resource of the resources accessible to the proposed location corresponds to a resource generated by the at least one component during production of methanol at the methanol production facility using the proposed configuration, and, at 450, determining, based at least in part on the identified resources accessible to the proposed location, whether to omit at least one component of the plurality of components identified by the proposed configuration. At 460, determining the alternative configuration includes omitting the at least one component from the alternative configuration of the methanol production facility in response to a determination that the at least one resource corresponds to the resource generated by the at least one component.

At 470, the method 400 includes generating a report based on the proposed configuration and the alternative configuration. In an aspect, the report may be the report 104 of FIG. 1. The report may include information indicating a difference between the proposed configuration and the alternative configuration. Additionally, the report may include first cost information representative of a difference between a first cost and a third cost and second cost information representative of a difference between a second cost and a fourth cost over the period of time. The first cost and the third cost may correspond to an amount of capital expenditure required to construct the methanol production facility using the proposed configuration and the alternative configuration, respectively. The second cost and the fourth cost may correspond to operational expenses for operating the methanol production facility configured according to the proposed configuration and the alternative configuration, respectively, over a period of time. Using the method 400 to configure a methanol production facility may increase the operational reliability and the safety of the methanol production facility, and may enable an entity to better evaluate the financial risk associated with construction of a methanol production facility, and to reduce the financial risk by constructing the methanol production facility according to the alternative configuration.

Referring to FIG. 5, a block diagram of an exemplary proposed configuration for a methanol production facility is shown. In an aspect, the proposed configuration for the methanol production facility shown in FIG. 5 may correspond to the proposed configuration included in a request (e.g., the request 102 or the request 106 of FIG. 1). In FIG. 5, the proposed configuration includes the HDS component 210 of FIG. 2, the reforming component 220 of FIG. 2, the cooling component 230 of FIG. 2, the compression component 240 of FIG. 2, the methanol synthesis component 250 of FIG. 2, the PSA component 260 of FIG. 2, the power generation component 270 of FIG. 2, and the air separation component 280 of FIG. 2. Each of these components may operate as described with reference to FIG. 2. Further, as shown in FIG. 5, the reforming component 220 for the proposed configuration includes a fired heater 530, an SMR component 540, and an ATR component 550.

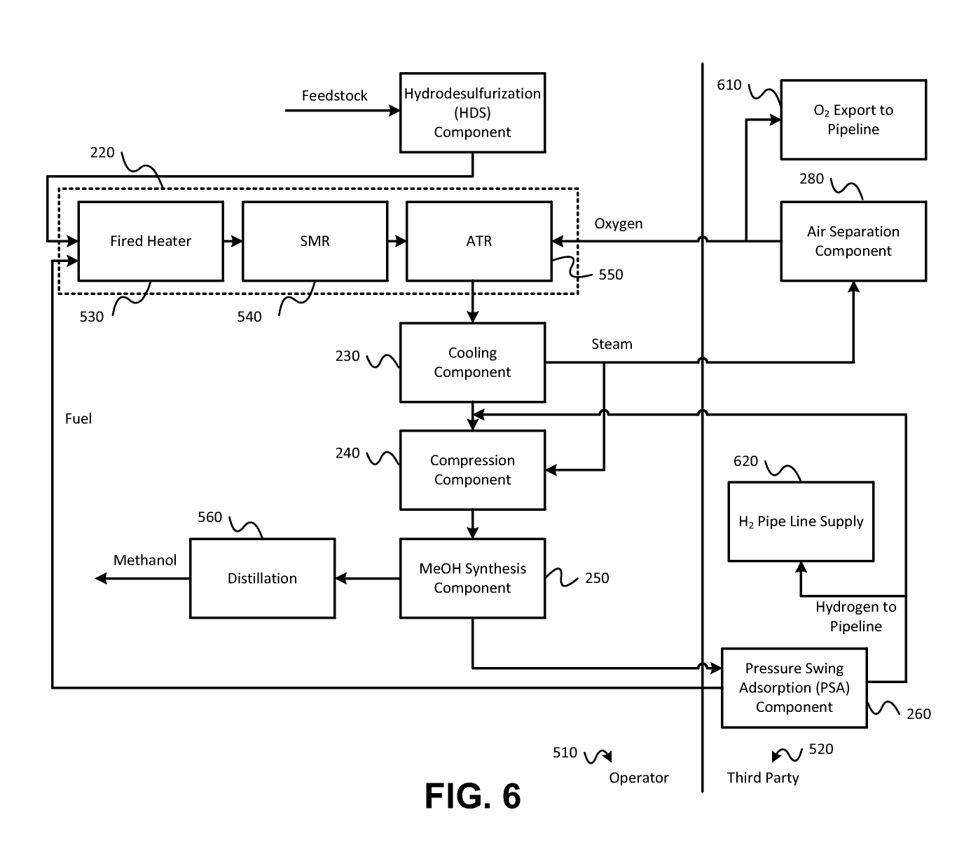

As additionally shown in FIG. 5, in the proposed configuration, the methanol production facility may include a distillation component 560. The distillation component may filter the output of the methanol synthesis component to generate a methanol stream and a raw water stream. The methanol stream may be provided to a methanol pipeline or stored at an on-site storage facility for subsequent sale and transport. The water stream output from the distillation component may be provided to a wastewater treatment facility which may be located on-site (not shown in FIGS. 2 and 5-7) at the methanol production facility, or may be provided to a pipeline that transports the water stream to a remotely located wastewater treatment facility. In the proposed configuration illustrated in FIG. 5, all of the component of the methanol production facility may be operated by an operator 510, and the methanol production facility may not import resources from, or utilize components operated by a third party 520. It is noted that although the distillation component 560 is not shown in FIG. 2, the methanol production facility shown in FIG. 2 may include a distillation component in some aspects of the present disclosure. Further aspects associated with utilizing the proposed configuration illustrated in FIG. 5 to determine alternative configurations for the methanol production facility are described with reference to FIGS. 6-10.

Referring to FIG. 6, a block diagram of a first alternative configuration for a methanol production facility is shown. In an aspect, the first alternative configuration for the methanol production facility shown in FIG. 6 may include components of the proposed configuration illustrated in FIG. 5 and the components illustrated in FIG. 2, and may be determined by an electronic device (e.g., the electronic device 120 of FIG. 1) based on the proposed configuration included in the request (e.g., the request 102 or the request 106 of FIG. 1). As shown in FIG. 6, the first alternative configuration includes the same components as the proposed configuration (e.g., the HDS component 210 of FIG. 2, the reforming component 220 of FIG. 2, the cooling component 230 of FIG. 2, the compression component 240 of FIG. 2, the methanol synthesis component 250 of FIG. 2, the PSA component 260 of FIG. 2, the power generation component 270 of FIG. 2, and the air separation component 280 of FIG. 2). However, the first alternative configuration illustrated in FIG. 6 differs from the proposed configuration illustrated in FIG. 5 in that the air separation component 230 and the PSA component 260 are operated and provided by a third party 520. Thus, in the first alternative configuration, oxygen and hydrogen are imported to the methanol production facility from components operated by the third party 520. As described above, by importing oxygen and hydrogen from pipelines (e.g., pipelines providing access to resources from remote locations or from components located at or next to the methanol production facility), the CapEx for constructing the methanol production facility may be reduce significantly while the OpEx for operating the methanol production facility may be slightly increased. As illustrated in FIG. 6, a portion of the oxygen generated by the air separation component 280 may be provided to an oxygen pipeline, as indicated at 610, and a portion of the hydrogen generated by the PSA component 260 may be provided to a hydrogen pipeline, as indicated as 620.

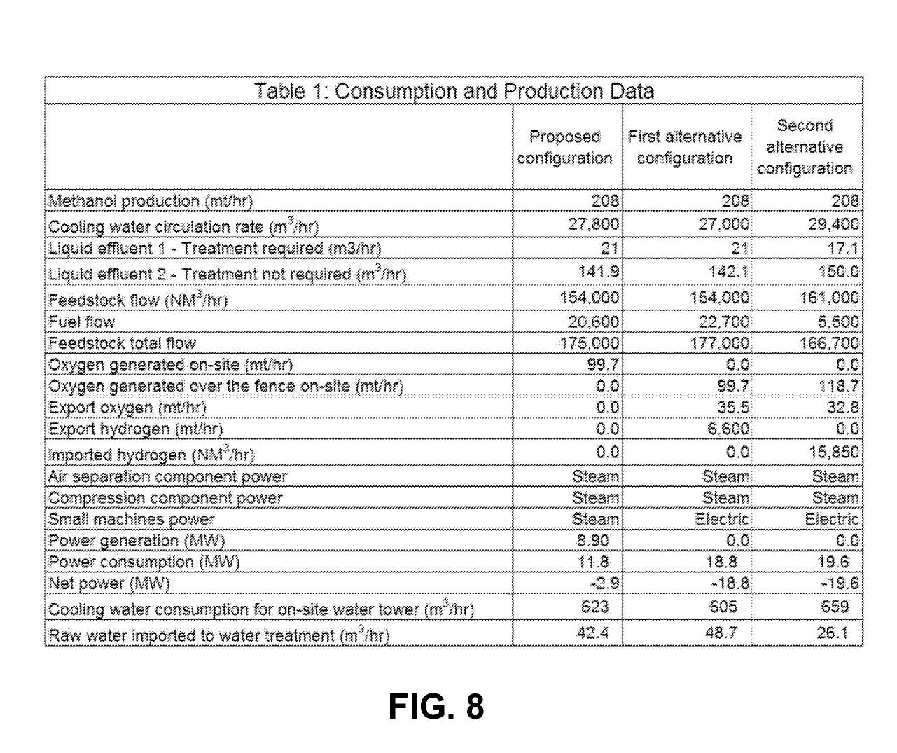

Additionally, the first alternative configuration differs from the proposed configuration in that at least a portion of the fuel provided to the fired heater may be offgas generated by the PSA component 260. Thus, in some aspects, all or a portion of the feedstock provided to the fired heater may be used for methanol production, rather than as fuel for the operation of the fired heater 530. This may reduce an amount of fluctuation in the OpEx caused by the market price of the feedstock, which may fluctuate daily/hourly. Further aspects illustrating the decreased CapEx and increased OpEx provided by the first alternative configuration are described with reference to FIGS. 8-10.

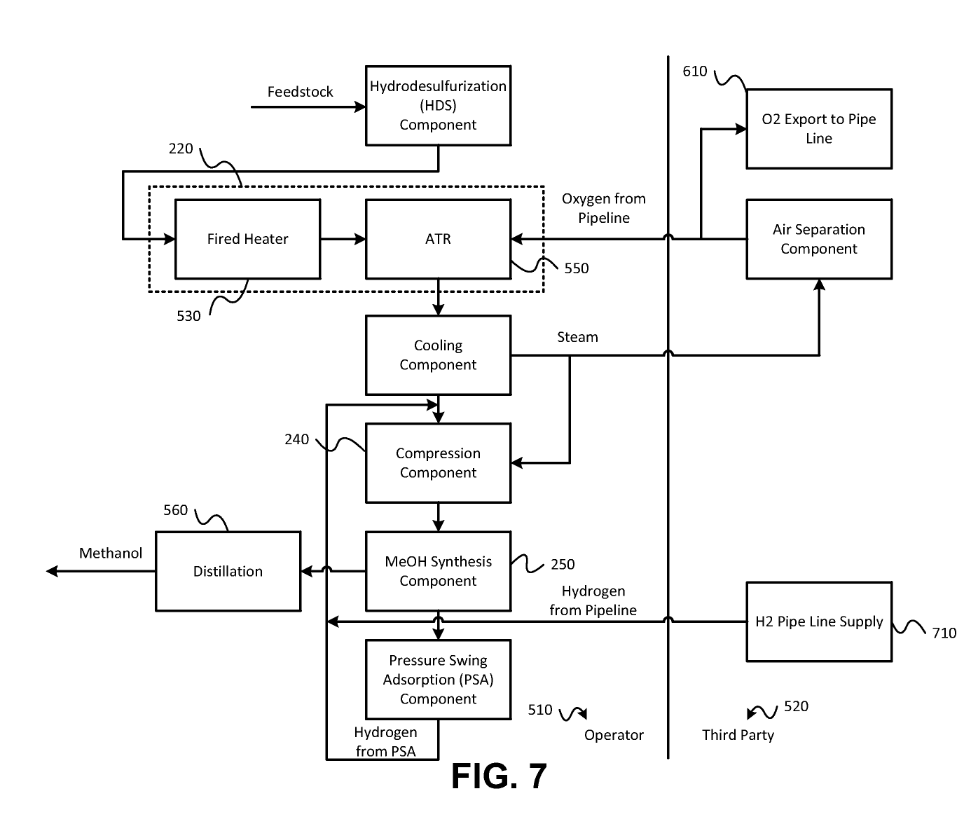

Referring to FIG. 7, a block diagram of a second alternative configuration for a methanol production facility is shown. In an aspect, the second alternative configuration for the methanol production facility shown in FIG. 6 may include components of the proposed configuration illustrated in FIG. 5 and the components illustrated in FIG. 2, and may be determined by an electronic device (e.g., the electronic device 120 of FIG. 1) based on the proposed configuration included in the request (e.g., the request 102 or the request 106 of FIG. 1). As shown in FIG. 7, the second alternative configuration includes the a different configuration of the components included in the proposed configuration (e.g., the HDS component 210 of FIG. 2, the reforming component 220 of FIG. 2, the cooling component 230 of FIG. 2, the compression component 240 of FIG. 2, the methanol synthesis component 250 of FIG. 2, the PSA component 260 of FIG. 2, the power generation component 270 of FIG. 2, and the air separation component 280 of FIG. 2). However, the second alternative configuration illustrated in FIG. 7 differs from the proposed configuration illustrated in FIG. 5 in that the air separation component 230 is operated and provided by a third party 520 and at least a portion of the hydrogen utilized by the methanol production facility is provided via the hydrogen pipeline 610. Thus, in the first alternative configuration, oxygen and hydrogen are imported to the methanol production facility from components operated by the third party 520.

As described above, by importing oxygen and hydrogen from pipelines (e.g., pipelines providing access to resources from remote locations or from components located at or next to the methanol production facility), the CapEx for constructing the methanol production facility may be reduce significantly while the OpEx for operating the methanol production facility may be slightly increased. Further aspects illustrating the decreased CapEx and increased OpEx provided by the first alternative configuration are described with reference to FIGS. 8-10.

Referring to FIG. 8, a table illustrating exemplary consumption and production data for a proposed configuration of a methanol production facility and two alternative configurations for the methanol production facility is shown as Table 1. In an aspect, the proposed configuration may be the proposed configuration of FIG. 5, a first alternative configuration of the two alternative configurations may be the first alternative configuration of FIG. 6, and a second alternative configuration of the two alternative configurations may be the second alternative configuration of FIG. 7. In FIG. 8, the following abbreviations are used: mt/hr (metric tons per hour); m³/hr (cubic meters per hour); NM³/hr (normal cubic meters per hour); and MW (megawatt). NM³/hr may correspond to a rate of flow a gas (e.g., oxygen or hydrogen) when measured at a predetermined temperature and pressure. Additionally, it is noted that the sample data was generated under an assumption that each of the configurations would output 5,000 metric tons of methanol per day.

As indicated in Table 1 of FIG. 8, each of the configurations has a methanol production rate of 208 mt/hr. The proposed configuration has a cooling water circulation rate of 27,800 m³/hr, while the first alternative configuration and the second alternative configuration have cooling water circulation rates of 27,000 and 29,400 m³/hr, respectively. The proposed configuration and the first alternative configuration may each generate 21 m³/hr of a first liquid effluent (e.g., wastewater) that requires treatment (e.g., at a wastewater treatment facility located on-site or remote from the methanol production facility), while the second alternative configuration may generate 17.1 m3/hr of the first liquid effluent that needs to be treated. The first liquid effluent may be treated by a separate on-site treatment unit (not shown in FIGS. 2 an 5-7) or may be treated by an external third party. After treatment, the first treated liquid effluent may be returned to the methanol production facility as demin water for subsequent reuse (e.g., as boiler feed water). Each of the configurations may also generate a second liquid effluent (e.g., wastewater) that does not requirement treatment. For example, as shown in FIG. 8, the proposed configuration may generate 141.9 m³/hr of the second liquid effluent that does not require treatment, the first alternative configuration may generate 142.1 m³/hr of the second liquid effluent that does not require treatment, and the second alternative configuration may generate 150.0 m³/hr of the second liquid effluent that does not require treatment. For the second liquid effluent, the level of pollution in the wastewater is typically lower or non-existent, and, in some cases, may be returned directly to a river or other body of water.

Because the first liquid effluent requires treatment, an OpEx associated with the first liquid effluent may be higher than an OpEx associated with the second liquid effluent. Additionally, the OpEx associated with treating the liquid effluent that requires treatment may be the same for the proposed configuration and the first alternative configuration, and may be lower for the second alternative configuration due to the lower volume of liquid effluent that requires treatment. Further, because the second liquid effluent does not require treatment, the OpEx associated with the second liquid effluent may be lower than the OpEx associated with the first liquid effluent.

Each of the configurations may receive a feedstock (e.g., a hydrocarbon feedstock such as natural gas) that is to be used to generate the methanol. The proposed configuration and the first alternative configuration may have a feedstock flow of 154,000 NM³/hr, and the second alternative configuration may have a feedstock flow of 161,000 NM³/hr. Thus, OpEx associated with the feedstock may be the same for the proposed configuration and the first alternative configuration, and is lower than an OpEx associated with the feedstock for the second alternative configuration. Each of the configurations may receive fuel that is used to operate a fired heater (e.g., the fired heater 530 of FIGS. 5-7) during production of the methanol. As illustrated in FIG. 8, the proposed configuration may have a fuel flow of 20,600 NM³/hr, the first alternative configuration may have a fuel flow of 22,700 NM³/hr, and the second alternative configuration may have a fuel flow of 5,500 NM³/hr. An OpEx associated with the fuel may be higher for the first alternative configuration relative to the proposed configuration (e.g., due to the higher fuel flow), and may be lower for the second alternative configuration relative to the proposed configuration (e.g., due to the lower fuel flow).

As shown in FIG. 8, the total feedstock flow for the proposed configuration may be 175,000 NM³/hr, the total feedstock flow for the first alternative configuration may be 177,000 NM³/hr, and the total feedstock flow for the second alternative configuration may be 166,700. Thus, it can be seen that the second alternative configuration produces a same amount of methanol (e.g., 208 mt/hr) as the proposed configuration and the second alternative configuration using less total feedstock.

In the proposed configuration, the oxygen used to produce the methanol may be produced by an on-site air separation unit (e.g., the air separation unit 280 of FIG. 5). As shown in FIG. 8, the proposed configuration may use 99.7 mt/hr of oxygen generated by the on-site air separation unit while the first and second alternative configurations may not use any oxygen produced by an on-site air separation unit. Additionally, and as shown in FIG. 8, the proposed configuration may not utilize any oxygen provided over the fence (e.g., via pipelines from remote or on-site air separation units operated by a third party) while the first alternative configuration uses 99.7 mt/hr of oxygen provided over the fence, and the second alternative configuration uses 118.7 mt/hr of oxygen provided over the fence.

Some of the configurations may generate excess hydrogen. For example, as shown in FIG. 8, the first alternative configuration may generate 6,600 mt/hr of excess hydrogen, as shown in FIG. 6. The excess hydrogen may be sold and provided to a pipeline, which may reduce the OpEx for some configurations (e.g., the first alternative configuration). Some of the configurations may import hydrogen (e.g., from a pipeline). For example, the second alternative configuration may import 15,850 mt/hr of hydrogen, which may increase the OpEx associated with the second alternative configuration.

As illustrated in FIG. 8, the air separation component, the compression component, and small machines (e.g., pumps, fans, coolers, condensers, etc.) may be powered entirely by steam (e.g., the proposed configuration), or may be powered by a combination of steam and electric power sources (e.g., the first alternative configuration and the second alternative configuration). In the proposed configuration, the methanol production facility may generate 8.9 MW of power for powering the methanol production facility, while the first and second alternative configurations may not generate power. By not generating power, CapEx associated with the first and second alternative configurations may be reduced (e.g., by omitting a power generation component). As illustrated in FIG. 8, the proposed configuration may have a total power consumption of 11.8 MW and a net power of −2.9 MW (e.g., power generated−total power consumption or 8.9 MW−11.8 MW), the first alternative configuration may have a total power consumption of 18.8 MW and a net power of −18.8 MW (e.g., power generated−total power consumption or 0.0 MW−18.8 MW), and the second alternative configuration may have a total power consumption of 19.6 MW and a net power of −19.6 MW (e.g., power generated−total power consumption or 0.0 MW−19.6 MW). Thus, the first and second alternative configurations may have a higher OpEx associated with powering the methanol production facility, where the OpEx associated with power for the second alternative configuration is higher relative to the OpEx associated with power for the first alternative configuration.

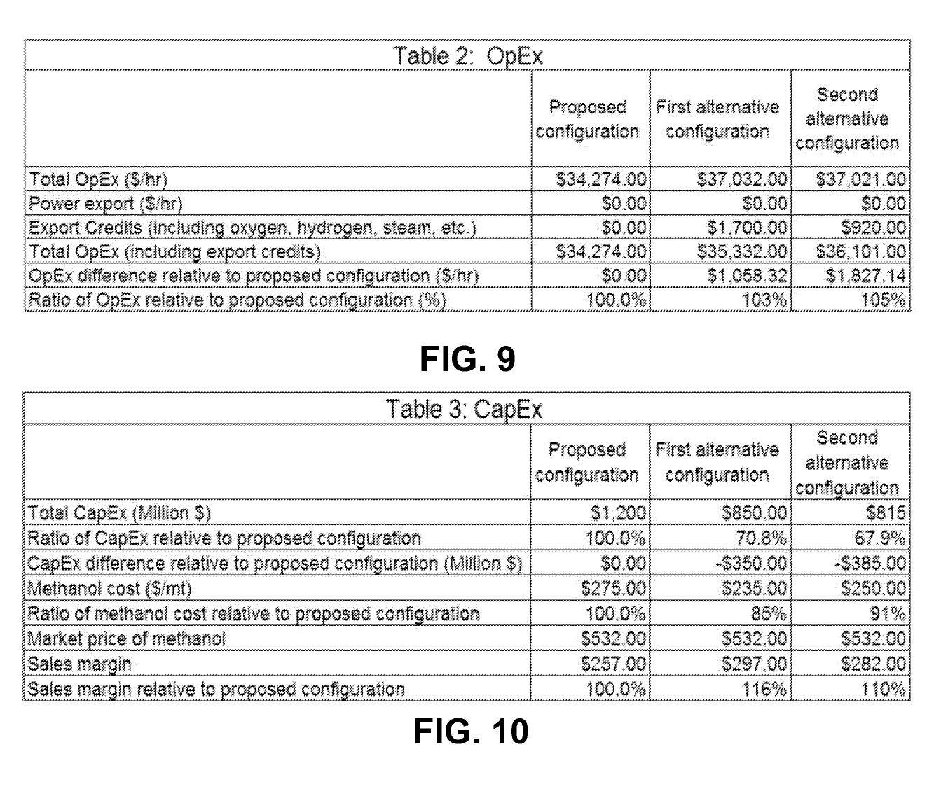

As shown in FIG. 8, the proposed configuration may consume cooling water at a rate of 623 m³/hr, the first alternative configuration may consume cooling water at a rate of 605 m³/hr, and the second alternative configuration may consume cooling water at a rate of 659 m³/hr. Additionally, the proposed configuration may import 42.4 m³/hr of raw water (e.g., an output of the distillation component 560 of FIGS. 5-7) for water treatment, the first alternative configuration may import 48.7 m³/hr of raw water for water treatment, and the second alternative configuration may import 26.1 m³/hr of raw water for water treatment. Further illustrative aspects of CapEx and OpEx for the proposed configuration and the first and second alternative configurations are described below with reference to Tables 2 and 3 of FIGS. 9 and 10, respectively.

Referring to FIG. 9, a table illustrating aspects of operational expenses for operating a methanol production facility according to a proposed configuration and two alternative configurations is shown as Table 2. As shown in Table 2, the total OpEx for the proposed configuration (e.g., the configuration illustrated in FIG. 5) is $34,274/hr, the total OpEx for the first alternative configuration (e.g., the configuration illustrated in FIG. 6) is $37,032/hr, and the total OpEx for the second alternative configuration (e.g., the configuration illustrated in FIG. 7) is $37,021/hr. As shown in Table 2, the proposed configuration does not receive an offset for OpEx from export credits. The first proposed configuration receives offsets for OpEx of $1,700/hr from export credits, and the second proposed configuration receives offsets for OpEx of $920/hr from export export credits. Thus, when offsets are accounted for, the total OpEx for each of the configurations is $34,274/hr for the proposed configuration, 35,332/hr for the first alternative configuration, and $36,101/hr for the second alternative configuration.

It can be seen from Table 2 that the first alternative configuration has an OpEx difference relative to the proposed configuration of $1,058/hr, and the second alternative configuration has an OpEx difference relative to the proposed configuration of $1,827/hr. Stated another way, and as shown in Table 2, the first alternative configuration increases OpEx by 3% relative to the proposed configuration, and the second alternative configuration increases OpEx 5% relative to the proposed configuration (as shown in the last row of Table 2).

Referring to FIG. 10, a table illustrating aspects of capital expenditure for constructing a methanol production facility according to a proposed configuration and two alternative configurations is shown as Table 3. In an aspect, the proposed configuration may correspond to the configuration illustrated with reference to FIG. 5, the first alternative configuration may correspond to the configuration illustrated with reference to FIG. 6, and the second alternative configuration may correspond to the configuration illustrated with reference to FIG. 7. As shown in Table 3, the total CapEx for the proposed configuration is $1,200M, the total CapEx for the first alternative configuration is $850M, and the total CapEx for the second alternative configuration is $815M. Thus, the methanol production facility may be constructed according to the first alternative configuration for 70.8% of the total CapEx for the proposed configuration, or may be constructed according to the second alternative configuration for 67.9% of the total CapEx for the proposed configuration. Stated another way, constructing the methanol production facility according to the first alternative configuration may reduce total CapEx for the methanol production facility by 29.2%, a $350M savings, and constructing the methanol production facility according to the second alternative configuration may reduce total CapEx for the methanol production facility by 32.1%, a $385M savings. Thus, Table 3 shows that the first alternative configuration and the second alternative configuration may result in a reduction in the CapEx for the methanol production facility in excess of 29%.

As further shown in Table 3, the cost to produce the methanol for the proposed configuration is $275/mt, the cost to produce the methanol for the proposed configuration is $235/mt, and the cost to produce the methanol for the proposed configuration is $250/mt. Thus, relative to the proposed configuration, the cost to produce the methanol is reduced for the first configuration and for the second configuration. As illustrated in Table 3 of FIG. 10, this may result in a higher sales margin for the methanol produced by a methanol production facility according to the first and second alternative configurations, resulting in a higher IRR for the methanol production facility. Thus, it can be seen from FIGS. 8-10, that determining an alternative configuration for a methanol production facility may significantly reduce (e.g., in excess of 29%) the CapEx for the methanol production facility while increasing OpEx slightly (e.g., 3%-5%).

It is appreciated that the illustrative aspects described herein may be implemented separately or in combination. Additionally, it is noted that one or more steps in the exemplary method illustrated in FIG. 4 may be implemented in a differing order or omitted all together. It is noted that the functional blocks, modules and processes illustrated in FIGS. 1-4 may include or utilize processors (e.g., the processors 122 of FIG. 1), electronics devices (e.g., the electronic device 120 of FIG. 1), hardware devices, electronics components, logical circuits, memories, software codes, firmware codes, etc., or any combination thereof.

Those of skill would further appreciate that the various illustrative logical blocks, modules, circuits, and algorithm steps described in connection with the present disclosure may be implemented as electronic hardware, computer software (e.g., the instructions 130 of FIG. 1, respectively), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system (e.g., the system 100 of FIG. 1). Skilled artisans may implement the described functionality in varying ways for each particular application, but such implementation decisions should not be interpreted as causing a departure from the scope of the present disclosure.

Additionally, the various illustrative logical blocks, modules, and circuits described in connection with the present disclosure may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary a range is expressed, it is to be understood that another embodiment is from the one.

Optional or optionally means that the subsequently described event or circumstances may or may not occur. The description includes instances where the event or circumstance occurs and instances where it does not occur.

Ranges may be expressed herein as from about one particular value, and/or to about another particular value. When such particular value and/or to the other particular value, along with all combinations within said range.

All references identified herein are each hereby incorporated by reference into this application in their entireties, as well as for the specific information for which each is cited.

What is claimed is:

1. A method comprising:
receiving one or more inputs corresponding to a proposed configuration of a methanol production facility, wherein the proposed configuration identifies a plurality of components utilized to produce methanol at the methanol production facility when configured according to the proposed configuration;
determining an alternative configuration of the methanol production facility, wherein the alternative configuration is different from the proposed configuration, and wherein determining the alternative configuration includes:
identifying, based on data stored at a database, resources accessible to a proposed location for the methanol production facility, wherein the identified resources are accessible from at least one source external to the methanol production facility, and wherein the identified resources are utilized to produce methanol at the methanol production facility using the proposed configuration;
determining whether at least one identified resource of the resources accessible to the proposed location corresponds to a resource generated by the at least one component during production of methanol at the methanol production facility using the proposed configuration; and
determining, based at least in part on the identified resources accessible to the proposed location, whether to omit at least one component of the plurality of components identified by the proposed configuration; and
omitting the at least one component from the alternative configuration of the methanol production facility in response to a determination that the at least one identified resource corresponds to the resource generated by the at least one component; and
generating a report based on the proposed configuration and the alternative configuration, wherein the report includes information indicating a difference between the proposed configuration and the alternative configuration.

2. The method of claim 1, wherein determining whether to omit the at least one component includes determining whether omitting the at least one component from the alternative configuration reduces an amount of carbon dioxide emission of the methanol production facility below a threshold level of carbon dioxide emissions, wherein the at least one component is omitted from the alternative configuration in response to a determination that omitting the at least one component from the alternative configuration reduces the amount of carbon dioxide emission of the methanol production facility below the threshold level of carbon dioxide emissions.

3. The method of claim 1, wherein the methanol production facility, when configured according to the alternative configuration, produces at least a same amount of methanol per unit of feedstock as the methanol production facility when configured according to the proposed configuration, and wherein the methanol production facility produces the methanol from the feedstock.

4. The method of claim 3, wherein the at least one component omitted from the alternative configuration generates the resource by consuming a portion of the feedstock during production of methanol using the proposed configuration, wherein omitting the at least one component prevents consumption of the portion of the feedstock during production of methanol using the alternative configuration, and wherein the methanol production facility, when configured according to the alternative configuration, produces a greater amount of methanol per unit of feedstock than an amount of methanol per unit of feedstock produced by the methanol production facility when configured according to the proposed configuration.

5. The method of claim 1, wherein the method includes determining scheduling information that includes a schedule for subsequently adding the at least one component to the methanol production facility during a period of time.

6. The method of claim 5, wherein the at least one component includes a scalable component including a plurality of sub-components, and wherein the method includes:
determining whether to add all of the plurality of sub-components included in the scalable component at once or to upgrade the scalable component incrementally, wherein upgrading the scalable component incrementally includes adding a first sub-component of the plurality of sub-components at a first time and adding a second sub-component of the plurality of sub-components at second time subsequent to the first time; and
in response to a determination to upgrade the scalable component incrementally, generating a time table for incrementally upgrading the scalable component during the period of time, wherein the time table is included in the schedule.

7. The method of claim 6, wherein an estimated OpEx associated with the scalable component decreases as the scalable component is upgraded according to the schedule, and wherein the report includes cost information that accounts for changes in the estimated OpEx associated with upgrading the scalable component.

8. The method of claim 1, wherein the method includes:
estimating, based on the proposed configuration, a first cost corresponding to an amount of capital expenditure required to construct the methanol production facility using the proposed configuration;
estimating a second cost corresponding to operational expenses for operating the methanol production facility configured according to the proposed configuration over a period of time;
estimating, based on the alternative configuration, a third cost corresponding to an amount of capital expenditure required to construct the methanol production facility using the alternative configuration, wherein the third cost is lower than the first cost; and
estimating a fourth cost corresponding to operational expenses for operating the methanol production facility configured according to the alternative configuration over the period of time, wherein the fourth cost is higher than the second cost,
wherein the report includes first cost information representative of a difference between the first cost and the third cost and second cost information representative of a difference between the second cost and the fourth cost over the period of time.

9. The method of claim 8, wherein the resources accessible to the proposed location correspond to resources provided via one or more pipelines, and wherein determining identifying the resources available to the proposed location includes:
determining a distance between each of the one or more pipelines and the proposed location; and
determining whether a distance between the proposed location each of the one or more pipelines is within a threshold distance; and
designating pipelines within the threshold distance as accessible pipelines, wherein resources provided by accessible pipelines are identified as the resources accessible to the proposed location.

10. The method of claim 9, wherein determining whether to omit the at least one component includes:
determining a cost of building infrastructure from the proposed location to each of the accessible pipelines;
selecting a subset of pipelines from among the accessible pipelines, wherein selection of a particular pipeline for inclusion in the subset of pipelines is based on the particular pipeline being associated with a lowest infrastructure cost, the infrastructure cost corresponding to a cost of building infrastructure from the proposed location to the particular pipeline, and wherein the subset of pipelines includes a single pipeline for each of the resources accessible to the proposed location; and
generating the third cost, based at least in part on infrastructure costs associated with each of the subset of pipelines.

11. The method of claim 10, wherein the method includes identifying one or more alternative locations for the methanol production facility based on an analysis of resources accessible to each of the one or more alternative locations, wherein each of the one or more alternative locations is accessible to a greater number of resources utilized in the production of methanol using the methanol production facility as compared to the proposed location.

12. The method of claim 11, wherein the method includes:
determining at least one additional alternative configuration of the methanol production facility, wherein the at least one additional alternative configuration is different from the proposed configuration and the alternative configuration;
estimating, based on the at least one additional alternative configuration, at least one additional cost corresponding to an amount of capital expenditure required to construct the methanol production facility using the at least one additional alternative configuration, wherein the third cost is lower than at least the first cost; and
estimating at least one additional cost corresponding to operational expenses for operating the methanol production facility configured according to the at least one additional alternative configuration over a period of time.

13. The method of claim 12, wherein the method includes, calculating an internal rate of return (IRR) for each of the configurations of the methanol production facility, wherein the report includes information indicating the IRR calculated for each of the configurations of the methanol production facility.

14. The method of claim 12, wherein the report includes a first set of additional cost information representative of a difference between the first cost and the at least one additional cost corresponding to the amount of capital expenditure required to construct the methanol production facility using the at least one additional alternative configuration and a difference between the second cost and the at least one additional cost corresponding to the operational expenses for operating the methanol production facility configured according to the at least one additional alternative configuration over the period of time.

15. An apparatus comprising:
a processor; and
a memory coupled to the processor, the memory storing instructions that, when executed by the processor, cause the processor to perform operations comprising:
receiving one or more inputs corresponding to a proposed configuration of a methanol production facility, wherein the proposed configuration identifies a plurality of components utilized to produce methanol at the methanol production facility when configured according to the proposed configuration;
determining an alternative configuration of the methanol production facility, wherein the alternative configuration is different from the proposed configuration, and wherein determining the alternative configuration includes:
identifying, based on data stored at a database, resources accessible to a proposed location for the methanol production facility, wherein the identified resources are accessible from at least one source external to the methanol production facility, and wherein the identified resources are utilized during production of methanol at the methanol production facility using the proposed configuration;
determining whether at least one identified resource of the resources accessible to the proposed location corresponds to a resource generated by the at least one component during production of methanol at the methanol production facility using the proposed configuration; and
determining, based at least in part on the identified resources accessible to the proposed location, whether to omit at least one component of the plurality of components identified by the proposed configuration; and
omitting the at least one component from the alternative configuration of the methanol production facility in response to a determination that the at least one identified resource corresponds to the resource generated by the at least one component; and
generating a report based on the proposed configuration and the alternative configuration, wherein the report includes information indicating a difference between the proposed configuration and the alternative configuration.

16. The apparatus of claim 15, wherein the operations include:
identifying a set of pipelines that are within a threshold distance to a proposed location for the methanol production facility, the proposed location identified by one of the one or more inputs;
determining a first set of resources accessible from the set of pipelines;
determining a second set of resources utilized in producing methanol at the methanol production facility using the proposed configuration;
estimating an infrastructure cost for each pipeline of the set of pipelines, wherein, for a particular pipeline of the set of pipelines, the infrastructure cost corresponds to a cost to build infrastructure from the proposed location to the particular pipeline to provide the proposed location with access to a resource included in the second set of resources; and
identifying a subset of pipelines from among the set of pipelines, the subset of pipelines including a single pipeline selected from among the set of pipelines for each resource that is included in both the first set of resources and the second set of resources, wherein each pipeline included in the subset of pipelines is associated with a lowest infrastructure cost for each resource that is included in both the first set of resources and the second set of resources, wherein the identified resources correspond to resources provided by the subset of pipelines.

17. The apparatus of claim 16, wherein a set of components of the plurality of components generate at least a portion of the second set of resources utilized in producing methanol at the methanol production facility using the proposed configuration, and wherein determining the alternative configuration includes:
determining, based on the resources provided by the subset of pipelines, a first set of components of the set of components that may be omitted from the proposed configuration of the methanol production facility; and
determining, based on resources provided by the subset of pipelines, a second set of components of the set of components that may not be omitted from the proposed configuration of the methanol production facility,
wherein the first set of components are removed in the alternative configuration,
wherein the second set of components are retained in the alternative configuration, and
wherein resources generated by the first set of components are to be provided by the subset of pipelines in the alternative configuration.

18. The apparatus of claim 17, wherein the operations include:
estimating, based on the proposed configuration, a first cost corresponding to an amount of capital expenditure required to construct the methanol production facility using the proposed configuration;
estimating a second cost corresponding to operational expenses for operating the methanol production facility configured according to the proposed configuration over a period of time;
estimating a cost to purchase the resources from one or more operators of the subset of pipelines;
estimating, based on the alternative configuration, a third cost corresponding to an amount of capital expenditure required to construct the methanol production facility using the alternative configuration, wherein the third cost is lower than the first cost; and
estimating a fourth cost corresponding to operational expenses for operating the methanol production facility configured according to the alternative configuration over the period of time, wherein the fourth cost is higher than the second cost, wherein the fourth cost is determined based at least in part on the cost to purchase the resources from the one or more operators, and wherein the report includes first cost information representative of a difference between the first cost and the third cost and second cost information representative of a difference between the second cost and the fourth cost over the period of time.

19. The apparatus of claim 15, wherein the operations include estimating a time frame for upgrading the methanol production facility from the alternative configuration to the proposed configuration.

20. The apparatus of claim 15, wherein the operations include generating a risk analysis for each configuration of the methanol production facility, wherein the report includes information associated with the risk analysis generated for each configuration.

21. A computer-readable storage device storing instructions that, when executed by a processor, cause the processor to perform operations comprising:
receiving one or more inputs corresponding to a proposed configuration of a methanol production facility, wherein the proposed configuration identifies a plurality of components utilized to produce methanol at the methanol production facility when configured according to the proposed configuration;
determining an alternative configuration of the methanol production facility, wherein the alternative configuration is different from the proposed configuration, and wherein determining the alternative configuration includes:
identifying, based on data stored at a database, resources accessible to a proposed location for the methanol production facility, wherein the identified resources are accessible from at least one source external to the methanol production facility, and wherein the identified resources are utilized during production of methanol at the methanol production facility using the proposed configuration;
determining whether at least one identified resource of the resources accessible to the proposed location corresponds to a resource generated by the at least one component during production of methanol at the methanol production facility using the proposed configuration; and
determining, based at least in part on the identified resources accessible to the proposed location, whether to omit at least one component of the plurality of components identified by the proposed configuration; and
omitting the at least one component from the alternative configuration of the methanol production facility in response to a determination that the at least one identified resource corresponds to the resource generated by the at least one component; and
generating a report based on the proposed configuration and the alternative configuration, wherein the report includes information indicating a difference between the proposed configuration and the alternative configuration.

22. The computer-readable storage device of claim 21, wherein the operations include determining an operational reliability of the methanol production facility according to the proposed configuration and the alternative configuration, wherein the report includes information associated with the operational reliability of the methanol production facility according to the proposed configuration and the alternative configuration.

23. The computer-readable storage device of claim 21, wherein the operations include:
identifying a set of pipelines that are within a threshold distance to a proposed location for the methanol production facility, the proposed location identified by one of the one or more inputs;
determining a first set of resources accessible from the set of pipelines;
determining a second set of resources utilized in producing methanol at the methanol production facility using the proposed configuration;
estimating an infrastructure cost for each pipeline of the set of pipelines, wherein, for a particular pipeline of the set of pipelines, the infrastructure cost corresponds to a cost to build infrastructure from the proposed location to the particular pipeline to provide the proposed location with access to a resource included in the second set of resources; and
identifying a subset of pipelines from among the set of pipelines, the subset of pipelines including a single pipeline selected from among the set of pipelines for each resource that is included in both the first set of resources and the second set of resources, wherein each pipeline included in the subset of pipelines is associated with a lowest infrastructure cost for each resource that is included in both the first set of resources and the second set of resources, wherein the identified resources correspond to resources provided by the subset of pipelines.

24. The computer-readable storage device of claim 23, wherein the operations include:
estimating, based on the proposed configuration, a first cost corresponding to an amount of capital expenditure required to construct the methanol production facility using the proposed configuration;
estimating a second cost corresponding to operational expenses for operating the methanol production facility configured according to the proposed configuration over a period of time;
estimating a cost to purchase the resources from one or more operators of the subset of pipelines;
estimating, based on the alternative configuration, a third cost corresponding to an amount of capital expenditure required to construct the methanol production facility using the alternative configuration, wherein the third cost is lower than the first cost; and
estimating a fourth cost corresponding to operational expenses for operating the methanol production facility configured according to the alternative configuration over the period of time, wherein the fourth cost is higher than the second cost, wherein the fourth cost is determined based at least in part on the cost to purchase the resources from the one or more operators, and wherein the report includes first cost information representative of a difference between the first cost and the third cost and second cost information representative of a difference between the second cost and the fourth cost over the period of time.

25. The computer-readable storage device of claim 24, wherein the operations include:
determining at least one additional alternative configuration of the methanol production facility, wherein the at least one additional alternative configuration is different from the proposed configuration and the alternative configuration;
estimating, based on the at least one additional alternative configuration, at least one additional cost corresponding to an amount of capital expenditure required to construct the methanol production facility using the at least one additional alternative configuration, wherein the third cost is lower than at least the first cost; and
estimating at least one additional cost corresponding to operational expenses for operating the methanol production facility configured according to the at least one additional alternative configuration over a period of time,
wherein the report includes a first set of additional cost information representative of a difference between the first cost and the at least one additional cost corresponding to the amount of capital expenditure required to construct the methanol production facility using the at least one additional alternative configuration and a difference between the second cost and the at least one additional cost corresponding to the operational expenses for operating the methanol production facility configured according to the at least one additional alternative configuration over the period of time.

26. The computer-readable storage device of claim 21, wherein the operations include:
determining a first amount of carbon dioxide emissions based on the proposed configuration for the methanol production facility; and
determining a second amount of carbon dioxide emissions based on the alternative configuration for the methanol production facility, wherein the second amount of carbon dioxide emissions is lower than the first amount of carbon dioxide emissions, and wherein the report includes information representative of the first amount of carbon dioxide emissions and the second amount of carbon dioxide emissions.

27. The computer-readable storage device of claim 26, wherein the operations include:
determining a first amount of carbon credits based on the first amount of carbon dioxide emissions;
determining a second amount of carbon credits based on the second amount of carbon dioxide emissions;
determining a difference between the first amount of carbon credits and the second amount of carbon credits; and
offsetting a operational expense (OpEx) associated with the alternative configuration based on the difference between the first amount of carbon credits and the second amount of carbon credits, wherein the report includes information indicating the first amount of carbon credits, the second amount of carbon credits, and the offset to the OpEx associated with the alternative configuration.
